(19) United States
(12) Patent Application Publication
(10) Pub. No.: US 2026/0162619 A1
(43) Pub. Date: Jun. 11, 2026

(54) Gate Driving Circuit and Display Device Including the Same

(71) Applicant: LG Display Co., Ltd., Seoul (KR)

(72) Inventors: Bo Kyoung Kim, Paju-si (KR); Yeon Woo Shin, Paju-si (KR); Sang Hee Yu, Paju-si (KR); Moon Seok Jung, Paju-si (KR)

(21) Appl. No.: 19/358,419

(22) Filed: Oct. 15, 2025

(30) Foreign Application Priority Data
Dec. 6, 2024 (KR) 10-2024-0180127

(51) Int. Cl. G09G 3/3266; G09G 3/32

(52) U.S. Cl. CPC G09G 3/3266; G09G 3/32; G09G 2310/0267; G09G 2310/0286; G09G 2310/08; G09G 2330/021

(57) ABSTRACT

The present application provides a gate driving circuit and a display device including the same. The gate driving circuit includes a first circuit part and a second circuit part. The second circuit part includes a first transistor including a gate electrode connected to a Q node, a first electrode connected to a first clock node to which a clock signal is input, and a second electrode, a second transistor including a gate electrode to which a first gate voltage is applied, a first electrode connected to a QB node, and a second electrode connected to the Q node; and a capacitor connected between the gate electrode of the first transistor and the second electrode of the second transistor.

### CROSS-REFERENCE TO RELATED APPLICATIONS

This application claims priority to and the benefit of Republic of Korea Patent Application No. 10-2024-0180127, filed Dec. 6, 2024 in the Republic of Korea, the entire disclosure of which is expressly incorporated herein by reference as if fully set forth herein.

### TECHNICAL FIELD

The present disclosure relates to the field of display, and particularly to, for example, without limitation, a gate driving circuit and a display device including the same.

### DESCRIPTION OF THE RELATED ART

An electroluminescent display device includes self-emissive light-emitting elements, for example, organic light emitting diodes (OLEDs), which are arranged in respective sub-pixels, and has advantages of fast response speed, high luminous efficiency, high luminance, and a wide viewing angle. The electroluminescent display device not only has a fast response speed and excellent luminous efficiency, luminance, and viewing angle, but also can represent black gradation as complete black, and thus has excellent contrast ratio and color reproduction rate. Such an electroluminescent display device does not require a backlight unit and may be implemented on a plastic substrate, a thin glass substrate, and a metal substrate that are flexible materials.

An electroluminescence display includes a data driving circuit that supplies a data signal to data lines of a display panel in which pixels are provided, and a gate driving circuit that supplies a gate signal to gate lines of the display panel.

The description provided in the discussion of the related art section should not be assumed to be prior art merely because it is mentioned in or associated with that section. The discussion of the related art section may include information that describes one or more aspects of the subject technology, and the description in this section does not limit the disclosure.

### SUMMARY

To reduce the power consumption of the display panel, the transistors that configure the pixels of the display panel and the gate driver may be implemented by oxide transistors with a small leakage current. As a buffer of the gate driving circuit, an n-channel oxide transistor with a small leakage current may be used or a buffer in which an n-channel oxide transistor and a p-channel LTPS transistor are connected may be used. In this case, a transistor used as a buffer is susceptible to positive bias temperature stress (PBTS). When the transistor deteriorates due to accumulation of stress, the deterioration of the transistor affects a pulse of a gate signal that is output from the gate driving circuit, causing waveform distortion of the gate signal. As a result, the charging rate of the pixels may be lowered, and the image quality of the display device may be lowered.

Embodiments of the present disclosure solve the above-described shortcomings and/or limitations.

The present disclosure provides a gate driving circuit capable of reducing deterioration of a transistor that outputs a gate signal, and a display device including the same.

The limitations addressed by the embodiments of the present disclosure are not limited to those described above, and other limitations not described will be clearly understood by those skilled in the art from the following description.

A gate driving circuit according to one embodiment includes: a first circuit part that includes a Q1 node, a Q2 node, and a QB node, and is configured to output a pulse of a first output signal; and a second circuit part that is connected to the QB node and is configured to receive a first gate voltage and a clock signal and output at least a pulse of a second output signal. The second circuit part includes: a first transistor including a gate electrode connected to a Q node, a first electrode connected to a first clock node to which the clock signal is input, and a second electrode; a second transistor including a gate electrode to which the first gate voltage is applied, a first electrode connected to the QB node, and a second electrode connected to the Q node; and a capacitor connected between the gate electrode of the first transistor and the second electrode of the second transistor.

The first circuit part may include a plurality of p-channel transistors. Each of the first transistor and the second transistor may be an n-channel transistor. The second electrode of the first transistor may be connected to a second output node from which the pulse of the second output signal is output.

The second circuit part may further include a third transistor including a gate electrode connected to the Q2 node, a first electrode connected to the second electrode of the first transistor, and a second electrode to which a second gate voltage lower than the first gate voltage is applied. The first circuit part may include a plurality of p-channel transistors. Each of the first transistor, the second transistor, and the third transistor may be an n-channel transistor. The second electrode of the first transistor may be connected to the second output node from which the pulse of the second output signal is output.

The second circuit part may further include: a third transistor including a gate electrode connected to the Q node, a first electrode to which a first B clock signal is input, and a second electrode connected to the second output node from which the pulse of the second output signal is output; a fourth transistor including a gate electrode connected to the Q node, a first electrode connected to the second output node, and a second electrode to which a second gate voltage lower than the first gate voltage is applied; a fifth transistor including a gate electrode connected to the Q node, a first electrode to which a second B clock signal is input, and a second electrode connected to a third output node from which a pulse of a third output signal is output; and a sixth transistor including a gate electrode connected to the Q node, a first electrode connected to the third output node, and a second electrode to which the second gate voltage is applied. The first circuit part may include a plurality of p-channel transistors. Each of the first transistor, the second transistor, the third transistor, the fourth transistor, the fifth transistor, and the sixth transistor may be an n-channel transistor. A voltage of the clock signal that is input to the first electrode of the first transistor may be the first gate voltage before a pulse of the first B clock signal is generated.

The first circuit part may include a shift register including a plurality of p-channel transistors or an edge trigger including a plurality of p-channel transistors.

The first circuit part may include: a third transistor including a gate electrode connected to a second clock node, a first electrode connected to a VST node, and a second electrode connected to the Q2 node; a fourth transistor including a gate electrode connected to the QB node, a first electrode connected to the Q2 node, and a second electrode connected to a VGH node to which the first gate voltage is input; a fifth transistor including a gate electrode connected to a third clock node, a first electrode connected to a VGL node to which a second gate voltage lower than the first gate voltage is applied, and a second electrode connected to the QB node; a sixth transistor including a gate electrode connected to the VST node, a first electrode connected to the QB node, and a second electrode connected to the VGH node, a seventh transistor including a gate electrode connected to the Q1 node, a first electrode connected to a fourth clock node, and a second electrode connected to a first output node from which the pulse of the first output signal is output; an eighth transistor including a gate electrode connected to the QB node, a first electrode connected to the first output node, and a second electrode connected to the VGH node; and a ninth transistor including a gate electrode connected to the VGL node, a first electrode connected to the Q1 node, and a second electrode connected to the Q2 node. Each of the third transistor, the fourth transistor, the fifth transistor, the sixth transistor, the seventh transistor, the eighth transistor, and the ninth transistor may be a p-channel transistor.

The clock signal that is input to the first clock node may be a signal with a phase opposite to a clock signal that is input to the fourth clock node.

A pulse interval voltage of the clock signal that is input to the first clock node may be the first gate voltage. A pulse interval voltage of each of clock signals that are input to the second clock node, the third clock node, and the fourth clock node, respectively, may be the second gate voltage.

In an interval other than a pulse interval of the clock signal, the second gate voltage lower than the first gate voltage may be applied to each of the first clock node, the second clock node, the third clock node, and the fourth clock node. The second gate voltage that is input to each of the second clock node, the third clock node, and the fourth clock node may be equal to or lower than the second gate voltage that is applied to the first clock node.

A voltage waveform of the Q node may have a phase opposite to voltages of the Q1 node and the Q2 node. The voltage waveform of the Q node may have the same phase as a voltage of the QB node.

A waveform of the second output signal may be a waveform with a phase opposite to the first output signal.

The first circuit part may further include: a third transistor including a gate electrode connected to a second clock node, a first electrode connected to a VST node, and a second electrode connected to the Q2 node; a fourth transistor including a gate electrode connected to the VST node, a first electrode connected to the second clock node via a second capacitor, and a second electrode connected to a VGH node to which the first gate voltage is applied; a fifth transistor including a gate electrode connected to the second clock node via the second capacitor, a first electrode connected to the second clock node, and a second electrode connected to the QB node; a sixth transistor including a gate electrode connected to the Q2 node, a first electrode connected to the QB node, and a second electrode connected to the VGH node; a seventh transistor including a gate electrode connected to the Q1 node, a first electrode connected to a VGL node to which a second gate voltage lower than the first gate voltage is applied, and a second electrode connected to a first output node from which the pulse of the first output signal is output; an eighth transistor including a gate electrode connected to the QB node, a first electrode connected to the first output node, and a second electrode connected to the VGH node; and a ninth transistor including a gate electrode connected to the VGL node, a first electrode connected to the Q1 node, and a second electrode connected to the Q2 node.

A pulse interval voltage of the clock signal that is input to the first clock node may be the first gate voltage. A pulse interval voltage of a clock signal that is input to the second clock node may be the second gate voltage.

A pulse interval of the clock signal that is input to the second clock node may be greater than a pulse interval of the clock signal that is input to the first clock node.

A pulse interval of the first output signal may be greater than a pulse interval of the second output signal.

A display device according to one embodiment includes a display panel in which a plurality of data lines, a plurality of gate lines, a plurality of pixels connected to corresponding data lines and gate lines, and a gate driving circuit configured to output a gate signal to the plurality of gate lines are provided. Each of the plurality of pixels includes a plurality of n-channel transistors that are switched in response to the gate signal. The gate driving circuit includes a first circuit part that includes a Q1 node, a Q2 node, and a QB node, and is configured to output a pulse of a carry signal; and a second circuit part that is connected to the QB node, and is configured to receive a first gate voltage and a clock signal and output a pulse of the gate signal. The second circuit part includes a first transistor including a gate electrode connected to a Q node, a first electrode connected to a first clock node to which the clock signal is input, and a second electrode; a second transistor including a gate electrode to which the first gate voltage is applied, a first electrode connected to the QB node, and a second electrode connected to the Q node; and a capacitor connected between the gate electrode of the first transistor and the second electrode of the second transistor.

According to the embodiments of the present disclosure, it is possible to improve the power consumption of the display device, and to reduce accumulation of stress of the transistors that configure the gate driving circuit, to thereby reduce deterioration of the gate driving circuit. As a result, according to the embodiments of the present disclosure, it is possible to improve the falling characteristics of the pulse output from the gate driving circuit, to improve the reliability and lifetime of the gate driving circuit, and to improve the image quality of the display device.

The effects of the present disclosure are not limited to the effects described above, and other effects not described will be understood by those skilled in the art from the following description and the appended claims.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with embodiments of the disclosure.

### BRIEF DESCRIPTION OF THE DRAWINGS

The above and other objects, features, and advantages of the present disclosure will become more apparent to those of ordinary skill in the art by describing exemplary embodiments thereof in detail with reference to the attached drawings, in which:

FIG. 1 is a block diagram illustrating a display device according to an embodiment of the present disclosure;

FIGS. 2 and 3 are circuit diagrams illustrating an example of a pixel circuit of a display area according to the embodiment of the present disclosure;

FIG. 4 is a circuit diagram illustrating a gate driving circuit according to the embodiment of the present disclosure;

FIG. 5 is a circuit diagram illustrating a gate driving circuit according to another embodiment of the present disclosure;

FIG. 6 is a circuit diagram illustrating a gate driving circuit according to still another embodiment of the present disclosure;

FIG. 7 is a circuit diagram illustrating an example of a shift register circuit that can be applied to a first circuit part of the gate driving circuit illustrated in each of FIGS. 4 to 6;

FIG. 8 is a diagram schematically illustrating a configuration of a gate driver to which the gate driving circuit illustrated in FIGS. 4 and 7 can be applied;

FIG. 9 is a waveform chart illustrating input and output signals of the gate driver illustrated in FIG. 8 and voltages of main nodes;

FIGS. 10 to 15 are diagrams illustrating an operation of the gate driving circuit illustrated in FIG. 7 in stages;

FIGS. 16 to 17F are diagrams illustrating a simulation result of the gate driving circuit illustrated in FIG. 7;

FIG. 18 is a circuit diagram illustrating an example of an edge trigger circuit that can be applied to the first circuit part of the gate driving circuit illustrated in each of FIGS. 4 to 6;

FIG. 19 is a diagram schematically illustrating a configuration of a gate driver to which the gate driving circuit illustrated in each of FIGS. 4 and 18 can be applied;

FIG. 20 is a waveform chart illustrating input and output signals of the gate driver illustrated in FIG. 19 and voltages of main nodes; and

FIGS. 21 to 26 are diagrams illustrating an operation of the gate driving circuit illustrated in FIG. 18 in stages.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The advantages and features of the present disclosure and methods for accomplishing the same will be more clearly understood from embodiments described below with reference to the accompanying drawings. However, the present disclosure is not limited to the following embodiments but may be implemented in various different forms. Rather, the present embodiments will make the disclosure of the present disclosure complete and allow those skilled in the art to completely comprehend the scope of the present disclosure.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the present specification. Further, in describing the present disclosure, detailed descriptions of known related technologies may be omitted to avoid unnecessarily obscuring the subject matter of the present disclosure.

The terms such as “comprising,” “including,” “having,” and “consist of” used herein are generally intended to allow other components to be added unless the terms are used with the term “only.” Any references to singular may include plural unless expressly stated otherwise.

Components are interpreted to include an ordinary error range even if not expressly stated.

When a positional or interconnected relationship is described between two components, such as “on top of,” “above,” “below,” “next to,” “connect or couple with,” “crossing,” “intersecting,” or the like, one or more other components may be interposed between them, unless “immediately” or “directly” is used.

When a temporal antecedent relationship is described, such as “after”, “following”, “next to”, “before”, or the like, it may not be continuous on a time base unless “immediately” or “directly” is used.

The terms “first,” “second,” and the like may be used to distinguish elements from each other, but the functions or structures of the components are not limited by ordinal numbers or component names in front of the components.

The following embodiments can be partially or entirely bonded to or combined with each other and can be linked and operated in technically various ways. The embodiments can be carried out independently of or in association with each other.

Identical drawing symbols refer to identical components. In addition, some parts of the drawings may be exaggerated for effective description of the thickness, ratio, and dimensions of the components. The scale of the components depicted in the drawings is different from the actual scale for convenience of description, and is not limited to the scale depicted in the drawings.

“And/or” includes all of one or more combinations that may be defined by associated components. Throughout the specification, the term ‘A and/or B’ means A, B, or both A and B, unless otherwise stated, and the term ‘C to D’ means C or more and D or less, unless otherwise stated.

The singular expressions used in this specification include the plural expression unless the context clearly indicates otherwise. In this application, terms such as ‘comprising’ or ‘including’ should not be interpreted as necessarily including all the components or steps listed in the specification; some components or steps may be excluded, or additional components or steps may be included.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Also, when an element or layer is “connected,” “coupled,” or “adhered” to another element or layer denotes that the element or layer can not only be directly connected or adhered to the other element or layer, but also be indirectly connected or adhered to the other element or layer with one or more intervening elements or layers “disposed,” or “interposed” between the elements or layers, unless otherwise specified. It should be understood to mean that elements may be so disposed to directly contact each other, or may be so disposed without directly contacting each other.

When describing quantitative or numerical relationships, terms such as “equal” and “the same” generally denote “substantially equal” and “substantially the same”, or “similar or equal” and “similar or the same”. That is, on the basis of that two elements being equal or the same, a certain error range is permitted, such as one percent, five percent, ten percent, etc.

It will be apparent to those skilled in the art that various modifications and variations can be made to the embodiments of the present disclosure without departing from the technical idea or scope of the present disclosure. Thus, it is intended that the present disclosure covers the modifications and variations of this disclosure provided they come within the scope of the appended claims and their equivalents.

The pixel circuit and the gate drive circuit of the display device may include a plurality of transistors. The transistor may be implemented as a thin film transistor (TFT). The transistors may be implemented as an oxide thin film transistor (Oxide TFT) including an oxide semiconductor, a low temperature poly silicon TFT (LTPS TFT) including a low temperature poly silicon, and the like.

A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons may flow from a source to a drain. The n-channel transistor has a direction of a current flowing from the drain to the source. In the case of a p-channel transistor (p-channel metal-oxide semiconductor, since carriers are holes, a source voltage is higher than a drain voltage such that holes may flow from a source to a drain. In the p-channel transistor, since holes flow from the source to the drain, current flows from the source to the drain. It should be noted that a source and a drain of a transistor are not fixed. For example, a source and a drain may be changed according to an applied voltage. Therefore, the disclosure is not limited to a source and a drain of a transistor. In the following description, a source and a drain of a transistor will be referred to as a first electrode and a second electrode.

A gate signal swings between a gate-on voltage and a gate-off voltage. A transistor is turned on in response to a gate-on voltage and is turned off in response to a gate-off voltage. In the case of an n-channel transistor, the gate-on voltage may be a gate high voltage VGH, and the gate-off voltage may be a gate low voltage VGL. In the case of a p-channel transistor, the gate-on voltage may be the gate low voltage VGL, and the gate-off voltage may be the gate high voltage VGH.

Hereinafter, various embodiments of the present disclosure will be described in detail with reference to the accompanying drawings.

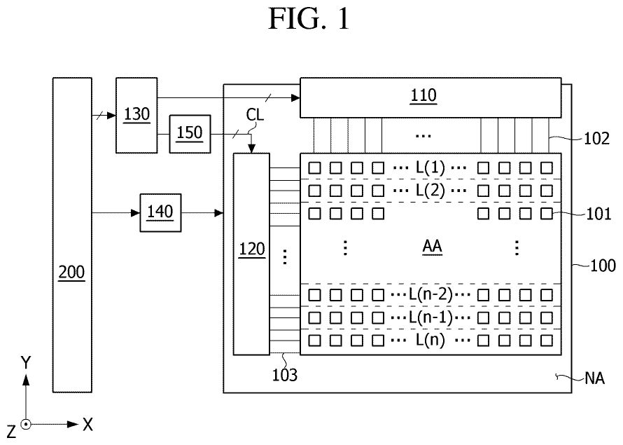

FIG. 1 is a block diagram illustrating a display device according to an embodiment of the present disclosure.

Referring to FIG. 1, the display device according to one embodiment of the present disclosure includes a display panel 100, display panel driving circuits 110 and 120 for writing image data to pixels 101 of the display panel 100, and a power circuit 140 for generating power necessary for driving the pixels 101 and the display panel driving circuits 110 and 120.

The display panel 100 may be, but is not limited to, a rectangular shaped panel having a width in the X-axis direction (first direction), a length in the Y-axis direction (second direction), and a thickness in the Z-axis direction (third direction). For example, at least a portion of the display panel 100 may have a curved outer periphery. The display panel 100 may be implemented as a non-transmissive display panel or a transmissive display panel. The transmissive display panel may be applied to a transparent display device in which an image is displayed on a screen and an actual object in the background is visible. The display panel 100 may be implemented as a flexible display panel.

The display panel 100 may include a display area AA and a non-display area NA outside the display area AA. The display area AA of the display panel 100 may include a pixel array for displaying images thereon. The pixel array may include a plurality of data lines 102, a plurality of gate lines 103 intersecting the data lines 102, and the pixels 101 arranged in a matrix form. The display panel 100 may further include a plurality of power lines commonly connected to the pixel circuits of the pixels 101. Each of the power lines contains a constant voltage node connected to the respective pixel circuit.

The pixels 101 may include two or more sub-pixels for color implementation. For example, each of the pixels 101 may be divided into a red sub-pixel, a green sub-pixel, and a blue sub-pixel. Each of the pixels 101 may further include a white sub-pixel. Each of the sub-pixel includes a pixel circuit for driving a light-emitting element. Each of the sub-pixels of the pixels 101 may be connected to the data line 102, the gate line 103, and the power line.

In the display area AA, the pixel array may include a plurality of pixel lines L(1) to L(n). Each of the pixel lines L(1) to L(n) may include one line of the pixels 101 arranged along the X-axis direction in the pixel array of the display panel 100. The pixels 101 arranged in one pixel line may share the gate lines 103. The pixels arranged along the Y-axis direction may share a data line 102. One horizontal period is a time obtained by dividing one frame period by the total number of pixel lines L(1) to L(N).

The driving circuits 110 and 120 of the display panel 100 write pixel data of the input image to the pixels under the control of the timing controller 130.

The timing controller 130 may receive the pixel data of the input image, and a timing signal synchronized with the pixel data from the host system 200. The timing signal may include a vertical synchronization signal Vsync, a horizontal synchronization signal Hsync, a main clock CLK, and a data enable signal DE. One cycle of the vertical synchronization signal Vsync may be a period of one frame. One cycle of the horizontal synchronization signal Hsync and the data enable signal DE may be one horizontal period 1H. The pulse of the data enable signal DE may be synchronized with one line of data to be written to the pixels 101 on one pixel line. Since a frame period and a horizontal period may be known by counting the data enable signal DE, the vertical synchronization signal Vsync and the horizontal synchronization signal Hsync may be omitted or may be briefly provided. The timing controller 130 may transmit the pixel data of the input image to the data driver 110 and control the operation timing of the data driver 110 and the gate driver 120. A gate timing control signal generated from the timing controller 130 may be input to the gate driver 120 through a level shifter 150.

The level shifter 150 may receive the gate timing control signal to output a start pulse and a clock. An input signal to the level shifter 150 may be a signal of a digital signal voltage level, and an output signal from the level shifter 150 may include pulses of an analog voltage that swings between a gate high voltage VGH and a gate low voltage VGL. The level shifter 150 may convert a low level voltage of the gate timing signal output from the timing controller 130 to the gate low voltage (VGL) and a high level voltage to the gate high voltage (VGH). The level shifter 150 and the gate driver 120 may be electrically connected via a clock line CL over which the start pulse and the clock are transmitted.

The data driver 110 may receive the pixel data of the input image received as a digital signal from the timing controller 130 and output a data voltage. The data driver 110 may convert the pixel data of the input image into a gamma compensated voltage using a digital-to-analog converter, hereinafter referred to as “DAC”, and output the data voltage. A gamma reference voltage output from the power circuit 140 may be divided into the gamma compensated voltage for each grayscale by a voltage divider circuit in the data driver 110 and supplied to the DAC. The DAC may generate the data voltage as the gamma compensated voltage corresponding to the grayscale value of the pixel data. The data voltage output from the DAC may be output to the data lines 102 through the output buffer in the respective channels of the data driver 110. The data voltage output from the data driver 110 may vary depending on the grayscale value of the pixel data. The data voltage may be determined according to the pixel data within a dynamic range between a maximum voltage and a minimum voltage that are determined based on the gamma reference voltage.

The circuit of the data driver 110 may be integrated into a drive IC (Integrated Circuit). The drive IC may be bonded to the display panel 100 using a chip on glass (COG) process, or it may be implemented as a chip on film (COF) and bonded to the display panel 100 and electrically connected to the data lines 102 and 104.

The gate driver 120 may be disposed on the display panel 100. The gate driver 120 may be disposed in the non-display area NA outside the display area AA in the display panel 100, or it may be partially disposed in the display area AA. The gate driver 120 may supply a gate signal to the gate lines 103 in a single feeding method. In the single feeding method, the gate signal may be applied at one ends of the gate lines 103. In a double feeding method, the gate signal may be applied simultaneously at both ends of the gate lines 103. The gate signal output from the gate driver 120 may be applied to the pixels 101.

A plurality of gate signals may be applied to the pixel circuits of the pixels 101. In this case, a plurality of gate lines 103 are connected to the pixel circuits so that the gate signals of different waveforms can be applied. The gate driver 120 may include a plurality of gate drivers that output different gate signals. Each of the gate drivers may include circuits such as shift registers, edge triggers, and the like to shift the pulses of the gate signals.

The power circuit 140 may include, but is not limited to, a charge pump, a regulator, a buck converter, a boost converter, and the like. The power circuit 140 may receive a direct current input voltage from the host system 200 to generate the power required to drive the driving circuits 110 and 120 of the display panel 100 and the pixels 101 of the display panel 100. The power circuit 140 may output a constant voltage (or DC voltage), such as the gamma reference voltage, the gate high voltage, the gate low voltage, etc. In addition, the power circuit 140 may output a constant voltage to be provided to the pixels 101. The gamma reference voltage may be supplied to the data driver 110. The gate high voltage VGH and the gate low voltage VGL may be supplied to the level shifter 150 and the gate driver 120. The constant voltages input to the pixel circuit, such as pixel driving voltage EVDD, pixel ground voltage EVSS, and the like may be applied to the pixels 101 and the pixels 101 through the power lines commonly connected to the pixels 101. The pixel ground voltage EVSS may be the cathode voltage. The power circuit 140 may be implemented as a power IC such as a power management integrated circuit (PMIC), an electronics integrated circuit (ELIC), or the like, but is not limited thereto.

The driving circuits 110 and 120 of the display panel 100 may be driven at a variable refresh rate (VRR) under the control of the timing controller 130. For example, the timing controller 130 may reduce power consumption of the display device by analyzing the input image and lowering the refresh rate when the input image does not change by a preset amount of time. In this case, the driving circuit of the display panel 100 may lower the refresh rate of the pixels P when a still image is input for a certain period of time or more under the control of the timing controller 130 to control a data writing period of the pixels P to be longer, thereby reducing the power consumption of the display device. The driving circuit of the display panel 100 may reduce the refresh rate when the display device is operated in standby mode or in response to a user command. Further, the refresh rate may be lowered in an always on display (AOD) screen. The AOD screen may be a small area of pixels in the display area AA in which preset information, for example, brief information such as remaining battery power, time, and the like are displayed in the standby mode.

The host system 200 may scale an image signal from a video source to match the resolution of the display panel 100, and may transmit it to the timing controller 130 together with the timing control signal.

Due to process deviations and device characteristic deviations occurring during the manufacturing process of the display panel 100, there may be differences in electrical characteristics of the driving elements across pixels, and such differences may increase as driving time of the pixels 101 elapses. To compensate for the deviations in the electrical characteristics of the driving elements across the pixels, an internal compensation circuit may be incorporated into the pixel circuit or the pixel circuit may be connected to an external compensation circuit. The internal compensation circuit is incorporated into the pixel circuit to sense the threshold voltage variation of the driving element and compensates the gate-source voltage of the driving element by the threshold voltage variation. The external compensation circuit may compensate for variation in the electrical characteristics of the driving element based on a compensation value selected based on the results of sensing the electrical characteristics of the driving element using the external compensation circuit connected to the pixel circuit.

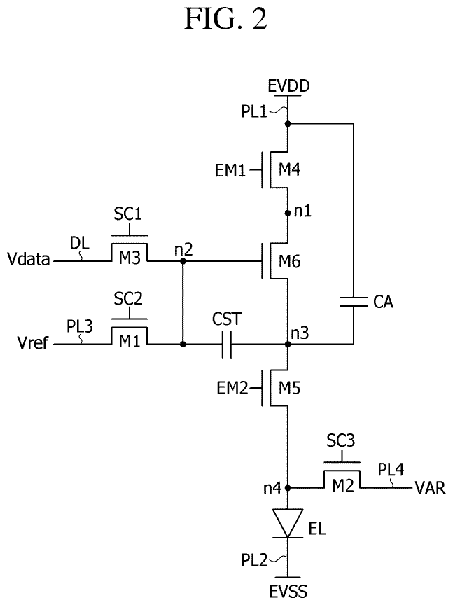

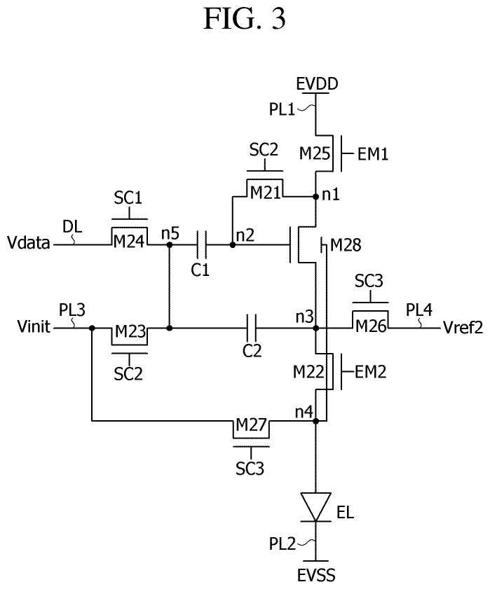

The pixel circuit may be implemented based on an n-channel oxide TFT as shown in FIGS. 2 and 3 in order to reduce power consumption. FIGS. 2 and 3 show one example of pixel circuits, including an internal compensation circuit based on an n-channel oxide TFT. It should be noted that the pixel circuits of the present disclosure is not limited to FIGS. 2 and 3. In FIGS. 2 and 3, PL1 to PL4 may be constant voltage nodes.

FIG. 2 is a circuit diagram illustrating a pixel circuit of a display area according to the embodiment of the present disclosure.

Referring to FIG. 2, the pixel circuit includes a driving element M6 for driving a light-emitting element EL, a plurality of switch elements M1 to M5, a first capacitor CST, and a second capacitor CA. The driving element M6 and the switch elements M1 to M5 may be implemented by n-channel Oxide TFTs, but the embodiments of the present disclosure are not limited thereto.

The light-emitting element EL may be implemented as an OLED or an inorganic LED such as a micro LED. The light-emitting element EL may include a capacitor present between an anode electrode and a cathode electrode. The OLED includes an anode electrode, a cathode electrode, and an organic compound layer interposed between these electrodes. The organic compound layer may include a hole injection layer (HIL), a hole transport layer (HTL), a light emission layer (EML), an electron transport layer (ETL), and an electron injection layer (EIL), but is not limited thereto. When a voltage is applied to the anode electrode and the cathode electrode of the light-emitting element EL, holes passing through the hole transport layer (HTL) and electrons passing through the electron transport layer (ETL) move into the light emission layer (EML) to form excitons. At this time, visible light is emitted from the light emission layer (EML). The OLED may be implemented as an OLED having a tandem structure in which a plurality of light emission layers are stacked. The OLED having the tandem structure may improve the luminance and lifetime of a pixel.

The anode electrode of the light-emitting element EL may be connected to a fourth node n4, and the cathode electrode of the light-emitting element EL may be connected to a second constant voltage node PL2 to which the pixel ground voltage EVSS is applied. The light-emitting element EL includes a capacitor formed between the anode electrode and the cathode electrode.

The driving element M6 generates a current according to a gate-source voltage Vgs and drives the light-emitting element EL. The gate-source voltage Vgs of the driving element M6 may be a voltage that is applied between a second node n2 and a third node n3. The driving element M6 includes a first electrode connected to a first node n1, a gate electrode connected to the second node n2, and a second electrode connected to the third node n3. The first capacitor CST is connected between the second node n2 and the third node n3. The second capacitor CA may be connected between a first constant voltage node PL1 and the third node n3.

Each of the switch elements M1 to M5 is turned on in response to a gate on voltage of a gate signal SC1, SC2, SC3, or EM applied to the gate electrode thereof and is turned off in response to a gate off voltage of the gate signal. In an n-channel transistor, the gate on voltage may be a gate high voltage (or a first gate voltage), and the gate off voltage may be a gate low voltage (or a second gate voltage) lower than the gate high voltage. The gate signals may include a first scan signal SC1, a second scan signal SC2, a third scan signal SC3, and a light emission signal (hereinafter, referred to as an “EM signal”). In this case, the gate driver 120 may include a first gate driver that outputs the first scan signal SC1, a second gate driver that outputs the second scan signal SC2, a third gate driver that outputs the third scan signal SC3, and a fourth gate driver that outputs the EM signal EM. Each of the first to fourth gate drivers may start to output a pulse of the gate signal in response to a start pulse and may shift the pulse in conformity with a shift clock timing.

A first switch element M1 is connected between a third constant voltage node PL3 to which a reference voltage Vref is applied and the second node n2, and is turned in response to the gate on voltage of the second scan signal SC2. When the first switch element M1 is turned on, the reference voltage Vref is applied to the second node n2. A second switch element M2 is connected between a fourth constant voltage node PL4 to which an anode reset voltage VAR is applied and the fourth node n4, and is turned on in response to the gate on voltage of the third scan signal SC3. When the second switch element M2 is turned on, the anode reset voltage VAR is applied to the fourth node n4. A third switch element M3 is connected between a data line DL to which a data voltage Vdata of pixel data is applied and the second node n2, and is turned on in response to the gate on voltage of the first scan signal SC1. When the third switch element M3 is turned on, the data voltage Vdata is applied to the second node n2. A fourth switch element M4 is connected between the first constant voltage node PL1 to which the pixel driving voltage EVDD is applied and the first node n1, and is turned on in response to a gate on voltage of a first EM signal EM1. When the fourth switch element M4 is turned on, the pixel driving voltage EVDD may be applied to the first node n1. A fifth switch element M5 is connected between the third node n3 and the fourth node n4, and is turned on in response to a gate on voltage of a second EM signal EM2. When the fifth switch element M5 is turned on, the third node n3 may be electrically connected to the fourth node n4.

FIG. 3 is a circuit diagram illustrating a pixel circuit of the display area according to another embodiment of the present disclosure. In this embodiment, redundant description to the pixel circuit illustrated in FIG. 2 will not be repeated.

Referring to FIG. 3, the pixel circuit includes a driving element M28, a plurality of switch elements M21 to M27, a first capacitor C1, and a second capacitor C2. The driving element M28 and the switch elements M21 to M27 may be implemented by n-channel Oxide TFTs, but the embodiments of the present disclosure are not limited thereto.

The anode electrode of the light-emitting element EL may be connected to a fourth node n4, and the cathode electrode of the light-emitting element EL may be connected to a second constant voltage node PL2 to which the pixel ground voltage EVSS is applied. The first capacitor C1 is connected between a second node n2 and a fifth node n5. The second capacitor C2 is connected between a third node n3 and the fifth node n5.

The driving element M28 may be a transistor having a double-gate structure. The driving element M28 includes a first gate electrode connected to the second node n2, a second gate electrode connected to the fourth node n4, a first electrode connected to a first node n1, and a second electrode connected to the third node n3.

Each of the switch elements M21 to M27 is turned on in response to a gate on voltage of a gate signal applied to a gate electrode thereof and is turned off in response to a gate off voltage of the gate signal. A first switch element M21 may be turned on a gate on voltage of a second scan signal SC2 and may electrically connect the first node n1 to the second node n2. A second switch element M22 may be turned on in response to a gate on voltage of a second EM signal EM2 and may form a current path between the driving element M28 and the light-emitting element EL. A third switch element M23 may be turned on in response to the gate on voltage of the second scan signal SC2 and may supply an initialization voltage Vinit to the fifth node n5. A fourth switch element M24 may be turned on in response to a gate on voltage of a first scan signal SC1 and may supply a data voltage Vdata to the fifth node n5. A fifth switch element M25 may be turned on in response to a gate on voltage of a first EM signal EM1 and may supply the pixel driving voltage EVDD to a first node n1. A sixth switch element M26 may be turned on in response to a gate on voltage of a third scan signal SC3 and may supply a reference voltage Vref2 to the third node n3. A seventh switch element M27 may be turned on in response to the gate on voltage of the third scan signal SC3 and may supply the initialization voltage Vinit to the fourth node n4.

A gate driving circuit that will be described in the following embodiment may output gate signals that are applied to gate electrodes of n-channel transistors used as switch elements of a pixel circuit as in FIGS. 2 and 3.

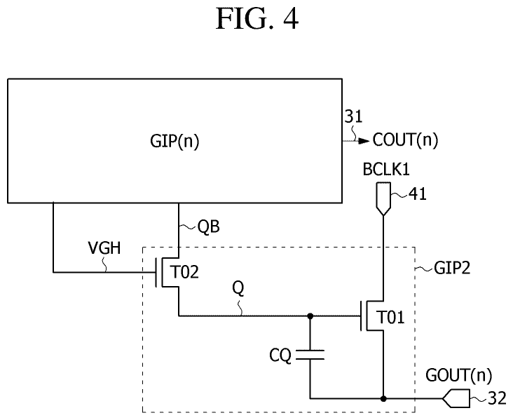

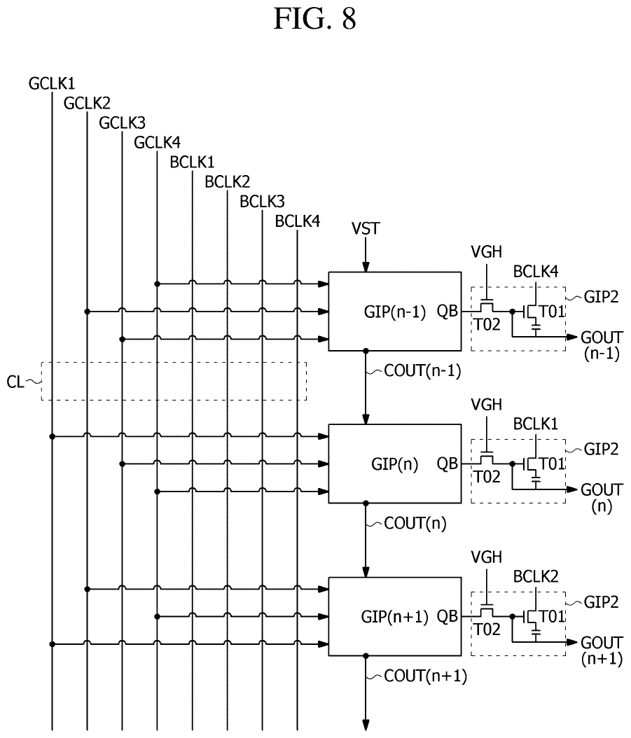

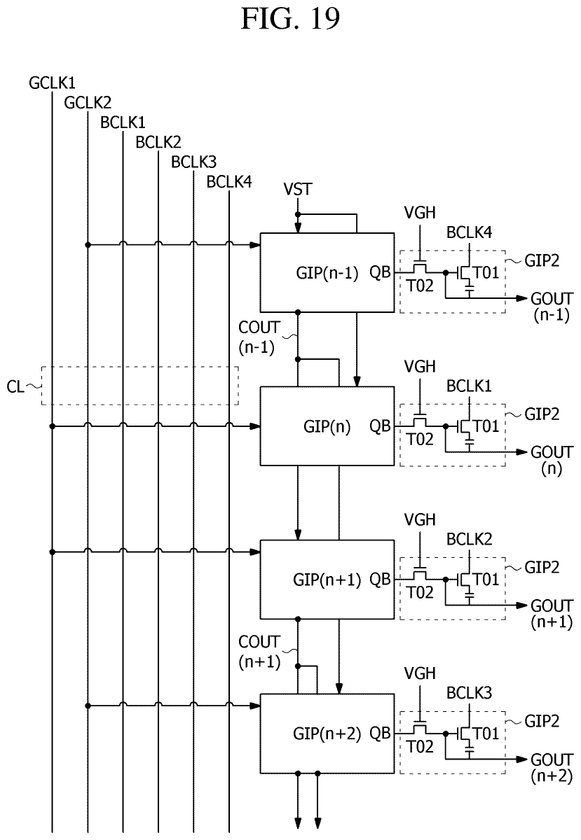

FIG. 4 is a circuit diagram illustrating a gate driving circuit according to the embodiment of the present disclosure. The gate driving circuit illustrated in FIG. 4 may be an n-th (where n is a positive integer) signal transmitter as illustrated in each of FIGS. 8 and 19.

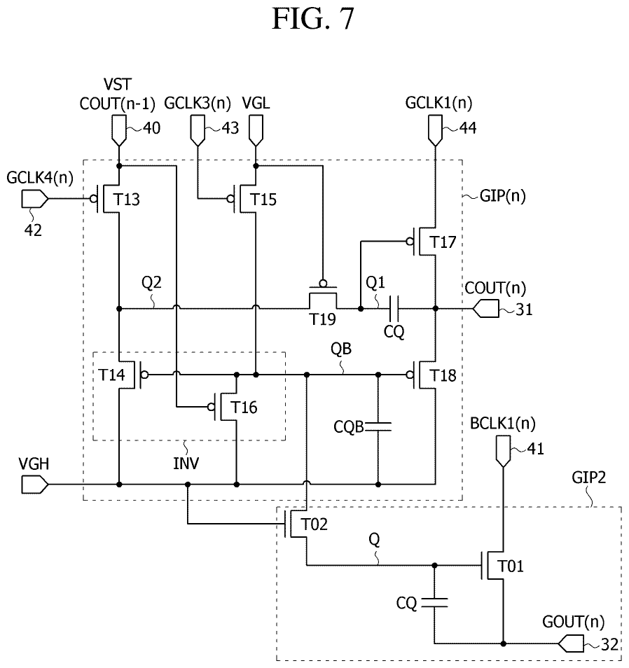

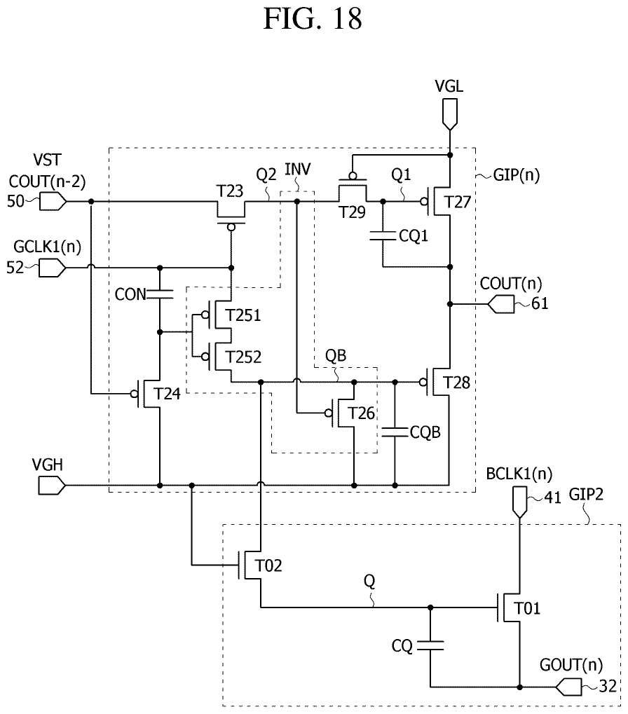

Referring to FIG. 4, the gate driving circuit includes a first circuit part GIP(n) and a second circuit part GIP2 that share at least one control node. The control nodes of the gate driving circuit charge and discharge output nodes 31 and 32 to control waveforms of output signals COUT(n) and GOUT(n). The control nodes of the gate driving circuit include a Q1 node, a Q2 node, a QB node, and a Q node as illustrated in each of FIGS. 7 and 18. The first circuit part GIP(n) and the second circuit part GIP2 may share at least the QB node.

The gate driving circuit outputs the pulses of the n-th output signals COUT(n) and GOUT(n). The n-th output signals COUT(n) and GOUT(n) include a first output signal COUT(n) and a second output signal GOUT(n). The first output signal COUT(n) is input as a carry signal to a VST node of a next signal transmitter, for example, an (n+1)th signal transmitter or an (n+2)th signal transmitter such that the pulse of the gate signal can be shifted. The second output signal GOUT(n) is a gate signal that is applied to the pixel circuit via a corresponding gate line. For example, the pulse of the second output signal GOUT(n) may be the pulse of the gate signal (SC1, SC2, SC3, or EM) illustrated in FIGS. 2 and 3.

The first circuit part GIP(n) charges and discharges the control nodes according to input signals and outputs the first output signal COUT(n). The signals input to the first circuit part GIP(n) may include a clock signal, a start pulse, a first output signal from a previous signal transmitter, and the like. The previous signal transmitter may be a first circuit part of an (n−1)th signal transmitter or an (n−2)th signal transmitter that generates the pulse of the output signal earlier than the n-th output signals COUT(n) and GOUT(n).

The first circuit part GIP(n) may be implemented by a p-channel transistor-based circuit. The control nodes of the first circuit part GIP(n) include the Q1 node, the Q2 node, and the QB node. When a voltage of the Q1 node is the gate low voltage, a pulse of a first output signal COUT(n) may be output through a first output node 31. A pulse interval voltage of the first output signal COUT(n) may be the gate low voltage. When a voltage of the QB node is the gate low voltage, a voltage of the first output node 31 change to the gate high voltage.

The second circuit part GIP2 may include a first transistor T01 and a second transistor T02. Each of the first and second transistors T01 and T02 may be implemented by an n-channel transistor. The second circuit part GIP2 may output the gate signal that is applied to the pixel circuit, in the form of a pulse of a second output signal GOUT(n) in response to the voltage of the QB node.

The first transistor T01 is an output transistor that outputs the pulse of the second output signal GOUT(n). The first transistor T01 includes a gate electrode connected to the Q node, a first electrode connected to a clock node 41 to which a B clock signal BCLK1 is input, and a second electrode connected to a second output node 32. The B clock signal BCLK1 may be generated with a phase opposite to a clock that controls an output timing of the first circuit part GIP(n).

A capacitor CQ may be connected between the gate electrode and the second electrode of the first transistor T01. The capacitor CQ may be connected between the Q node and the second electrode of the first transistor T01. In a state in which the Q node is precharged with the gate high voltage VGH, the Q node is coupled to the second output node 32 via the capacitor CQ and a voltage of the second output node 32 increases with a voltage of the B clock signal BCLK1, bootstrapping may occur. When the Q node is bootstrapped, a voltage of the Q node is boosted to a voltage higher than the gate high voltage VGH. As a result, a gate-source voltage of the first transistor T01 may become large, and the pulse of the second output signal GOUT(n) may rise fast to the gate high voltage. A pulse interval voltage of the second output signal GOUT(n) is the gate high voltage. The pulse interval voltage of the second output signal GOUT(n) may be the gate on voltage that turns on the switch element of the pixel circuit.

When the voltage of the Q node is charged with the gate high voltage and the pulse of the B clock signal BCLK1 is generated as the gate high voltage VGH, the first transistor T01 may be turned on. When the first transistor T01 is turned on, the pulse of the second output signal GOUT(n) is output. When the first transistor T01 is in an on state, the second transistor T02 is in an off state. When the voltage of the Q node is the gate low voltage, the first transistor T01 is turned off. When the first transistor T01 is in the off state, the voltage of the second output node 32 connected to the gate line may be the gate low voltage VGL, that is, the gate off voltage. When the first transistor T01 is in the off state, the second transistor T02 is in the on state.

The second transistor T02 is a switch element that electrically separates the Q node and QB node such that, when the voltage of the Q node is bootstrapped, the voltage of the QB node is not bootstrapped in conjunction with the bootstrapping of the Q node. The second transistor T02 includes a gate electrode to which the gate high voltage VGH is applied, a first electrode connected to the QB node, and a second electrode connected to the Q node. When the voltage of the QB node is changed from the gate low voltage VGL to the gate high voltage VGH, a voltage of the second electrode (source electrode) of the second transistor T02 may increase, the gate-source voltage Vgs of the second transistor T02 may become VGH−VGH=0 V, and the second transistor T02 may be turned off. When the second transistor T02 is turned off, the voltage of the Q node may be the gate high voltage VGH, and the first transistor T01 may be turned on.

When the voltage of the QB node is the gate low voltage VGL, the gate-source voltage of the second transistor T02 may become large to VGH-VGL, and the second transistor T02 may be turned on. When the second transistor T02 is turned on, the first transistor T01 is turned off.

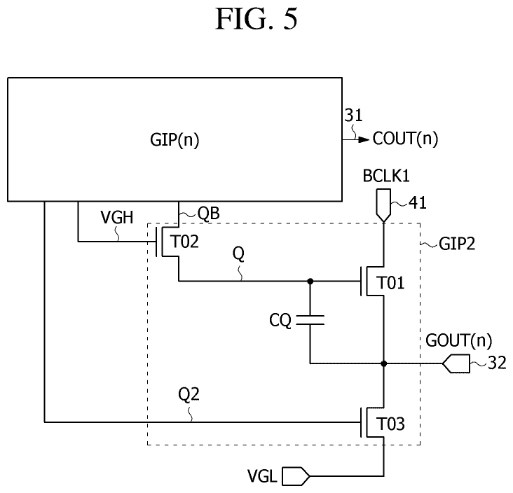

FIG. 5 is a circuit diagram illustrating a gate driving circuit according to another embodiment of the present disclosure. The gate driving circuit illustrated in FIG. 5 may be an n-th signal transmitter as illustrated in each of FIGS. 8 and 19. In this embodiment, the substantially same components as those in the above-described embodiment are represented by the same reference numbers, and redundant description thereof will not be repeated.

Referring to FIG. 5, a second circuit part GIP2 may include a first transistor T01, a second transistor T02, and a third transistor T03. Each of the transistors T01, T02, and T03 may be implemented by an n-channel transistor. The second circuit part GIP2 outputs a pulse of a second output signal GOUT(n) that is applied to the pixel circuit, in response to the voltage of the QB node.

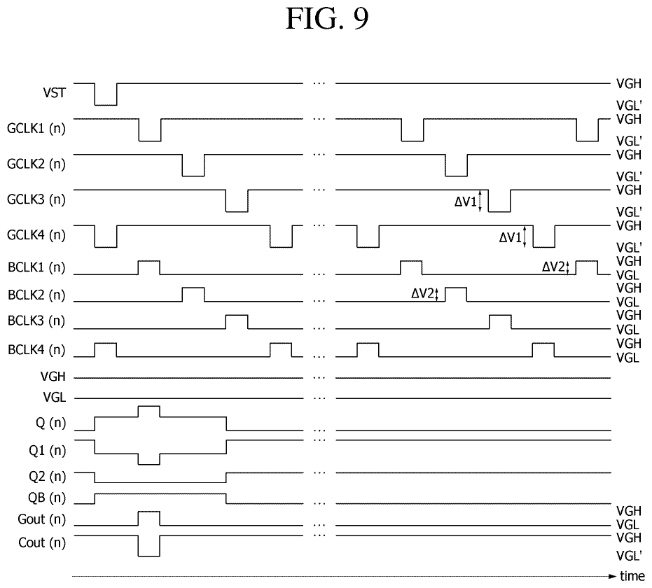

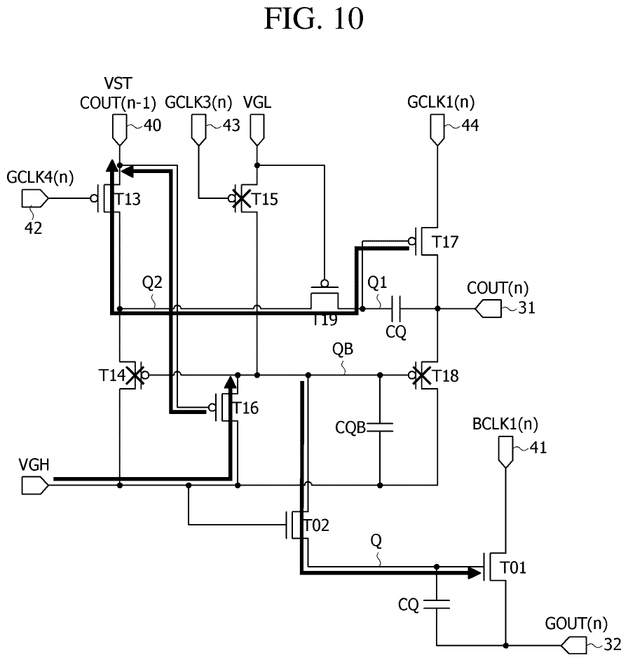

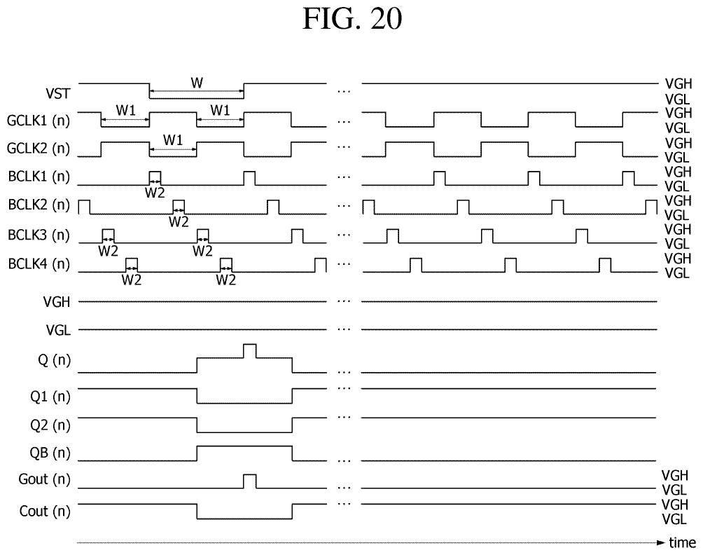

The third transistor T03 is turned on in response to a voltage of the Q2 node and electrically connects the second output node 32 to a VGL node to which the gate low voltage VGL is applied. The third transistor T03 includes a gate electrode connected to the Q2 node, a first electrode connected to the second electrode of the first transistor T01 and the second output node 32, and a second electrode connected to the VGL node. A voltage waveform of the Q2 node is a waveform with a phase opposite to the voltage of the Q node as illustrated in FIGS. 9 and 20. Accordingly, when the first transistor T01 is turned off, the third transistor T03 is turned on and the voltage of the second output node 32 connected to the gate line is discharged to the gate low voltage VGL. The gate low voltage that is applied to the gate line is the gate off voltage that is applied to the pixel circuit.

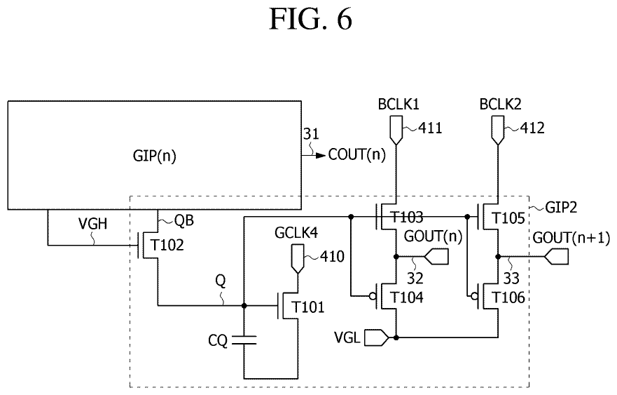

FIG. 6 is a circuit diagram illustrating a gate driving circuit according to still another embodiment of the present disclosure. The gate driving circuit illustrated in FIG. 6 may be an n-th signal transmitter as illustrated in FIGS. 8 and 19. In this embodiment, the substantially same components as those in the above-described embodiment are represented by the same reference numbers, and redundant description thereof will not be repeated.

Referring to FIG. 6, a second circuit part GIP2 may include first to sixth transistors T101 to T106. The second circuit part GIP2 sequentially outputs n-th and (n+1)th pulses of second output signals GOUT(n) and GOUT(n+1) via second and third output nodes 32 and 33 in response to first and second B clock signals BCLK1 and BCLK2. In a state in which the Q node is precharged with the gate high voltage VGH, when a pulse of the first B clock signal BCLK1 is generated as the gate high voltage VGH, the Q node may be bootstrapped, and a third transistor T103 may be turned on. Thereafter, when a pulse of the second B clock signal BCLK2 is generated as the gate high voltage VGH, the Q node may be bootstrapped again, and a fifth transistor T105 may be turned on. As a result, the n-th and (n+1)th pulses of the second output signals GOUT(n) and GOUT(n+1) may be sequentially output. Accordingly, in this embodiment, since the pulses of the gate signals output from one signal transmitter may be applied to the pixel circuits provided in a plurality of pixel lines, the number of signal transmitters of the gate driver 120 is reduced, and it is advantageous to implement a narrow bezel. The number of output transistors connected to the Q node is not limited to the number of output transistors illustrated in FIG. 6. For example, gate electrodes of two or more output transistors may share the Q node.

As illustrated in FIG. 9, before the pulse of the first B clock signal BCLK1 is generated, a G clock signal GCLK4 that is the gate high voltage VGH may be applied to a first transistor T101. A pulse interval voltage of the G clock signal GCLK4 may be the gate low voltage VGL. The first transistor T101 includes a gate electrode connected to the Q node, a first electrode connected to a first clock node 410 to which the G clock signal GCLK4 is input, and a second electrode coupled to the Q node via a capacitor CQ.

The third transistor T103 pulls up a voltage of the second output node 32 to the gate high voltage VGH when the pulse of the first B clock signal BCLK1 is input in a state in which the Q node is precharged. The third transistor T103 includes a gate electrode connected to the Q node, a first electrode connected to a second clock node 411 to which the first B clock signal BCLK1 is input, and a second electrode connected to the second output node 32.

The fifth transistor T105 pulls up a voltage of the third output node 33 to the gate high voltage VGH when the pulse of the second B clock signal BCLK2 is input in a state in which the Q node is precharged. The fifth transistor T105 includes a gate electrode connected to the Q node, a first electrode connected to a third clock node 412 to which the second B clock signal BCLK2 is input, and a second electrode connected to the third output node 33.

Fourth and sixth transistors T104 and T106 are pull-down transistors that pull down the voltage of the gate signal to the gate low voltage VGL. Each of the fourth and sixth transistors T104 and T106 may be implemented by a p-channel transistor. The fourth transistor T104 includes a gate electrode connected to the Q node, a first electrode connected to the second output node 32, and a second electrode connected to a VGL node to which the gate low voltage VGL is applied. The sixth transistor T106 includes a gate electrode connected to the Q node, a first electrode connected to the third output node 33, and a second electrode connected to the VGL node.

The first circuit part GIP(n) illustrated in FIGS. 4 and 7 may be implemented by a shift register illustrated in FIG. 8 or an edge trigger illustrated in FIG. 18, but the embodiments of the present disclosure are not limited thereto.

FIG. 7 is a circuit diagram illustrating an example of a shift register circuit that can be applied to the first circuit part of the gate driving circuit illustrated in each of FIGS. 4 to 6. In the circuit illustrated in FIG. 7, redundant description of the second circuit part GIP2 in the above-described embodiment will not be repeated.

Referring to FIG. 7, the first circuit part GIP(n) includes a Q1 node, a Q2 node, a QB node, and a plurality of transistors T13 to T19. Each of the transistors T13 to T19 may be implemented by a p-channel transistor, but the embodiments of the present disclosure are not limited thereto.

A third transistor T13 is connected between a VST node 40 and the Q2 node. The third transistor T13 is turned on in response to a fourth G clock signal GCLK4(n) and electrically connects the VST node 40 to the Q2 node. A start pulse VST or a carry signal from a first circuit part of a previous signal transmitter, for example, an (n−1)th signal transmitter or an (n−2)th signal transmitter, that is, a first output signal COUT(n−1) may be input to the VST node 40. When the third transistor T13 is turned on, the Q2 node may be discharged to the gate low voltage VGL of the VST node 40. The third transistor T13 includes a gate electrode connected to a second clock node 42 to which the fourth G clock signal GCLK4(n) is input, a first electrode connected to the VST node 40, and a second electrode connected to the Q2 node.

A fourth transistor T14 is connected between a VGH node and the Q2 node, and charges and discharges the Q2 node in response to a voltage of the QB node. When the voltage of the QB node is the gate high voltage VGH, the fourth transistor T14 may be turned off, and the Q2 node may be discharged to the gate low voltage VGL of the VST node 40. When the voltage of the QB node is the gate low voltage VGL, the fourth transistor T14 may be turned on, and the Q2 node may be electrically connected to the VGH node to which the gate high voltage VGH is applied. As a result, the voltage of the Q2 node may be changed to the gate high voltage VGH. The fourth transistor T14 includes a gate electrode connected to the QB node, a first electrode connected to the Q2 node, and a second electrode connected to the VGH node.

A fifth transistor T15 is connected between the VGL node and the QB node. The fifth transistor T15 may be turned on in response to a third G clock signal GCLK3(n) and may electrically connect the VGL node to the QB node. When the fifth transistor T15 is turned on, the voltage of the QB node may be discharged to the gate low voltage VGL. The fifth transistor T15 includes a gate electrode connected to a third clock node 43 to which the third G clock signal GCLK3(n) is input, a first electrode connected to the VGL node, and a second electrode connected to the QB node.

A sixth transistor T16 is connected between the QB node and the VGH node. The sixth transistor T16 may be turned on in response to a voltage of the VST node 40 and may electrically connect the QB node to the VGH node. When the sixth transistor T16 is turned on, the QB node may be charged with the gate high voltage VGH. The sixth transistor T16 includes a gate electrode connected to the VST node 40, a first electrode connected to the QB node, and a second electrode connected to the VGH node.

The fourth and sixth transistors T14 and T16 configure an inverter circuit INV that charges and discharges the voltage of the QB node to a voltage with a phase opposite to the voltage of the Q2 node.

Seventh and eighth transistors T17 and T18 are output transistors that output a pulse of a first output signal COUT(n). The seventh transistor T17 is connected between a fourth clock node 44 and a first output node 31, and is turned on in response to a voltage of the Q1 node. When the voltage of the Q1 node is the gate low voltage VGL, the seventh transistor T17 may be turned on, and the fourth clock node 44 may be electrically connected to the first output node 31. As a result, a voltage of a first G clock signal GCLK1(n) may be transmitted to the first output node 31. The seventh transistor T17 includes a gate electrode connected to the Q1 node, a first electrode connected to the fourth clock node 44 to which the first G clock signal GCLK1(n) is input, and a second electrode connected to the first output node 31. A capacitor CQ1 is connected between the Q1 node and the first output node 31. The capacitor CQ1 boosts the voltage of the Q1 node to a voltage lower than the gate low voltage with bootstrapping through capacitor coupling between the first output node 31 and the Q1 node when a voltage of the fourth clock node 44 increases.

The eighth transistor T18 is connected between the first output node 31 and the VGH node, and is turned on in response to the voltage of the QB node. When the voltage of the QB node is the gate low voltage VGL, the eighth transistor T18 is turned on, and the first output node 31 is connected to the VGH node. As a result, the voltage of the first output signal COUT(n) increases to the gate high voltage VGH. The eighth transistor T18 can reduce or prevent the occurrence of ripples in the voltage of the first output signal COUT(n) in an interval of the gate high voltage of the first output signal COUT(n). The eighth transistor T18 includes a gate electrode connected to the QB node, a first electrode connected to the first output node 31, and a second electrode connected to the VGH node. A capacitor CQB is connected between the QB node and the VGH node, and reduces fluctuation of the gate-source voltage of the eighth transistor T18.

A ninth transistor T19 is connected between the Q1 node and the Q2 node, and electrically separates the Q1 node and the Q2 node when the Q1 node is bootstrapped, thereby reducing stress of the third transistor T13. The ninth transistor T19 includes a gate electrode connected to the VGL node, a first electrode connected to the Q1 node, and a second electrode connected to the Q2 node.

As illustrated in FIG. 9, when the Q1 node is bootstrapped by a pulse of the first G clock signal GCLK1(n), the voltage of the Q1 node may be decreased to a voltage lower than the gate low voltage VGL. A source voltage of the ninth transistor T19 may be decreased to be equal to or lower than a gate voltage and the ninth transistor T19 may be turned off. For example, when a gate-source voltage Vgs of the ninth transistor T19 is VGL−VGL=0 V, the ninth transistor T19 may be turned off.

When the Q1 node and the Q2 node are integrated into one node and the node is bootstrapped, stress (high junction stress) of the third transistor T13 due to a drain-source voltage is increased to adversely affect the lifetime of the third transistor T13. During an interval where the Q2 node is charged with the voltage of the VST node, the gate-source voltage Vgs of the ninth transistor T19 may be Vgs=VGL−VGH, and the ninth transistor T19 may be turned on.

FIG. 8 is a diagram schematically illustrating a configuration of a gate driver to which the gate driving circuit illustrated in FIGS. 4 and 7 can be applied. FIG. 9 is a waveform chart illustrating input and output signals of the gate driver illustrated in FIG. 8 and voltages of main nodes.

Referring to FIGS. 8 and 9, a gate driver 120 includes signal transmitters that are connected in a cascade manner via clock lines CL and carry signal lines. The signal transmitters include first circuit parts GIP(n−1) to GIP(n+1) and second circuit parts GIP2, respectively.

The signal transmitters may receive the start pulse VST or first output signals COUT(n−1) to COUT(n+1) from previous signal transmitters and clock signals GCLK1 to GCLK4 and BCLK1 to BCLK4. The clock signals GCLK1 to GCLK4 and BCLK1 to BCLK4 may be divided into a G clock set GCLK1 to GCLK4 that is input to the first circuit parts GIP(n−1) to GIP(n+1) and a B clock set BCLK1 to BCLK4 that is input to the second circuit parts GIP2. As illustrated in FIG. 9, the G clock set GCLK1 GCLK4 and the B clock set BCLK1 to BCLK4 may be a four-phase clock in which a pulse is sequentially shifted, but the embodiments of the present disclosure are not limited thereto. The pulses of the G clock set GCLK1 to GCLK4 are shifted in an order of GCLK1(n), GCLK2(n), GCLK3(n), and GCLK4(n) on a time axis. The pulses of the B clock set BCLK1 to BCLK4 are shifted in an order of BCLK1(n), BCLK2(n), BCLK3(n), and BCLK4(n) on the time axis.

The clock signals of the B clock set BCLK1 to BCLK4 are generated with a phase opposite to the corresponding clock signals of the G clock set GCLK1 to GCLK4. For example, as illustrated in FIG. 9, a first B clock signal BCLK1 has a phase opposite to a first G clock signal GCLK1. A second B clock signal BCLK2 has a phase opposite to a second G clock signal GCLK2.

The start pulse VST may swing between the gate high voltage VGH and a gate low voltage VGL'. The pulses of the clock signals belonging to the G clock set GCLK1 to GCLK4 swing between the gate high voltage VGH and the gate low voltage VGL'. Pulses of first output signals COUT(n−1) to COUT(n+1) are synchronized with the pulses of the G clock set GCLK1 to GCLK4. The pulses of the first output signals COUT(n−1) to COUT(n+1) swing between the gate high voltage VGH and the gate low voltage VGL′ like the pulses of the G clock set GCLK1 to GCLK4.

The pulses of the clock signals belonging to the B clock set BCLK1 to BCLK4 swing between the gate high voltage VGH and the gate low voltage VGL. Pulses of second output signals GOUT(n−1) to GOUT(n+1) are synchronized with the pulses of the B clock set BCLK1 to BCLK4. The pulses of the second output signals GOUT(n−1) to GOUT(n+1) swing between the gate high voltage VGH and the gate low voltage VGL like the pulses of the B clock set BCLK1 to BCLK4. The gate high voltage VGH may be 7.6 V and the gate low voltage VGL may be −15.3 V, but the embodiments of the present disclosure are not limited thereto.

A pulse voltage ΔV1 of the G clock set GCLK1 to GCLK4 may be equal to or greater than a pulse voltage ΔV2 of the B clock set BCLK1 to BCLK4. The gate high voltage VGH of the G clock set GCLK1 to GCLK4 and the gate high voltage VGH of the B clock set BCLK1 to BCLK4 may be equal to each other, and the gate low voltages VGL′ and VGL may be set equal to or different from each other.

The gate low voltage VGL′ of the G clock set GCLK1 to GCLK4 may be equal to or lower than the gate low voltage VGL of the B clock set BCLK1 to BCLK4. As illustrated in FIG. 9, when the gate high voltage VGH of the G clock set GCLK1 to GCLK4 and the gate high voltage VGH of the B clock set BCLK1 to BCLK4 are equal to each other, and the gate low voltage VGL′ of the G clock set GCLK1 to GCLK4 is lower than the gate low voltage VGL of the B clock set BCLK1 to BCLK4, the pulse voltage ΔV1 of the G clock set GCLK1 to GCLK4 may be greater than the pulse voltage ΔV2 of the B clock set BCLK1 to BCLK4.

The charging and discharging characteristics of the Q1 node of the first circuit parts GIP(n−1) to GIP(n+1) by compensating for RC delay of the carry signal lines for transmitting the first output signals COUT(n−1) to COUT(n+1) to next signal transmitters when the pulse voltage ΔV1 of the G clock set GCLK1 to GCLK4 is large and the gate low voltage VGL′ is low, thereby improving the reliability of the gate driving circuit.

In the case of the n-channel transistors T01 and T02 that configure the second circuit part GIP2, when a positive voltage, for example, the gate high voltage is continuously applied to the gate electrode, the PBTS may be accumulated and deterioration may be accelerated. The clock signals of the B clock set BCLK1 to BCLK4 that is input to the second circuit part GIP2 are the gate high voltage in a pulse interval (or pulse width) of a short time, for example, a time equal to or less than one horizontal period and are the gate low voltage in most of one frame period. Accordingly, since the n-channel transistors T01 and T02 that output pulses of gate signals GOUT(n−1) to GOUT(n+1) are little susceptible to PBTS, a speed of deterioration progress can be significantly decreased, and the reliability and lifetime of the gate driving circuit can be improved. Since the transistors T01 and T02 have almost no PBTS, excellent falling characteristics can be secured in the second output signals GOUT(n−1) to GOUT(n+1) that are output from the second circuit parts GIP2.

As illustrated in FIG. 9, a voltage waveform of the Q node has a phase opposite to the voltages of the Q1 and Q2 nodes, and has the same phase as the voltage of the QB node. The first output signals COUT(n−1) to COUT(n+1) are output as the pulse of the gate low voltage VGL′ in synchronization with the pulse of the first G clock signal GCLK1 when the Q1 node is bootstrapped by the pulse of the first G clock signal GCLK1 and the voltage of the Q1 node is lower than the gate low voltage VGL′. The second output signals GOUT(n−1) to GOUT(n+1) are output as the pulse of the gate high voltage VGH in synchronization with the pulse of the first B clock signal BCLK1 when the Q node is bootstrapped by the pulse of the first B clock signal BCLK1 and the voltage of the Q node is higher than the gate high voltage VGH.

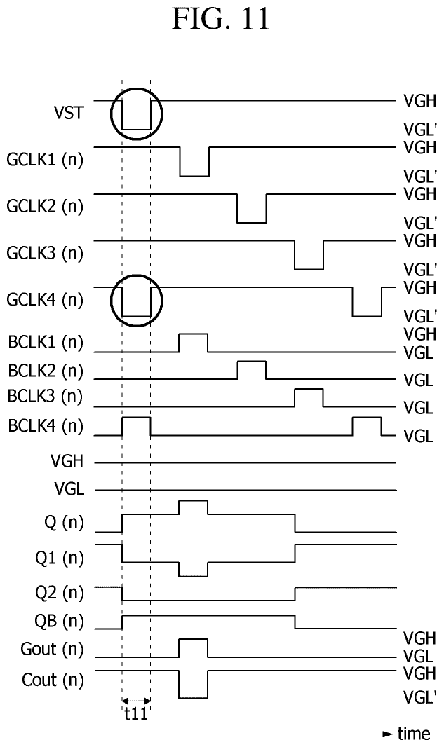

FIGS. 10 to 15 are diagrams illustrating an operation of the gate driving circuit illustrated in FIG. 7 in stages, in accordance with an embodiment.

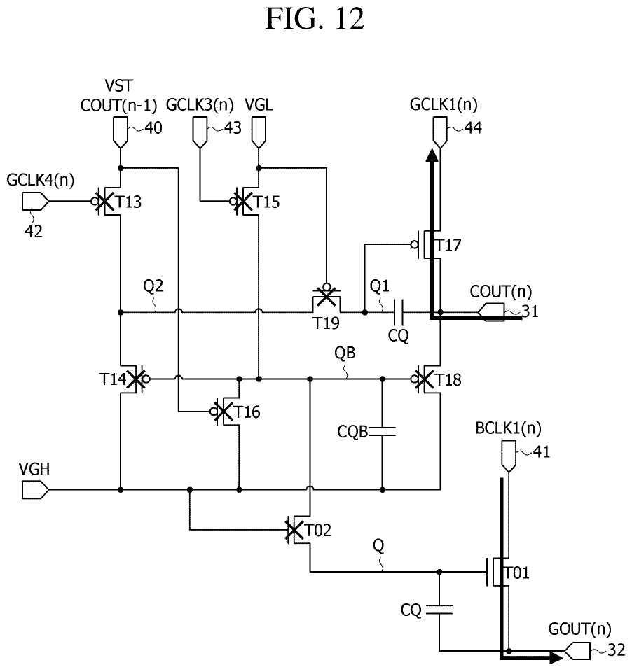

FIGS. 10 and 11 are a circuit diagram and a waveform chart illustrating an operation of the gate driving circuit illustrated in FIG. 7 in a t11 period, in accordance with an embodiment.

Referring to FIGS. 10 and 11, the first circuit part GIP(n) receives the start pulse VST and a pulse of a fourth G clock signal GCLK4(n) in the t11 period. In this case, the third and sixth transistors T13 and T16 are turned on in response to the gate low voltage VGL′. The fourth transistor T14, the fifth transistor T15, and the eighth transistor T18 are turned off in the t11 period.

In the t11 period, the ninth transistor T19 is in the on state. The second transistor T02 is turned on in response to the gate high voltage VGH in the t11 period and electrically connects a QB node QB(n) to a Q node Q(n). As a result, in the t11 period, voltages of a Q1 node Q1(n) and a Q2 node Q2(n) are decreased to the gate low voltage VGL′, and voltages of the QB node QB(n) and the Q node Q(n) are increased to the gate high voltage VGH.

The second transistor T02 is turned on in response to the voltage of the Q node Q(n) that increases to the gate high voltage VGH, in the t11 period. The seventh transistor T17 is turned on in response to the voltage of the Q1 node Q1(n) that is the gate low voltage VGL′, in the t11 period. In the t11 period, the voltage of the first G clock signal GCLK1(n) that is applied to the seventh transistor T17 is the gate high voltage VGH, and the voltage of the first B clock signal BCLK1(n) that is applied to the second transistor T02 is the gate low voltage VGL. Accordingly, in the t11 period, the voltage of the first output signal COUT(n) is the gate high voltage VGH, and the voltage of the second output signal GOUT(n) is the gate low voltage VGL.

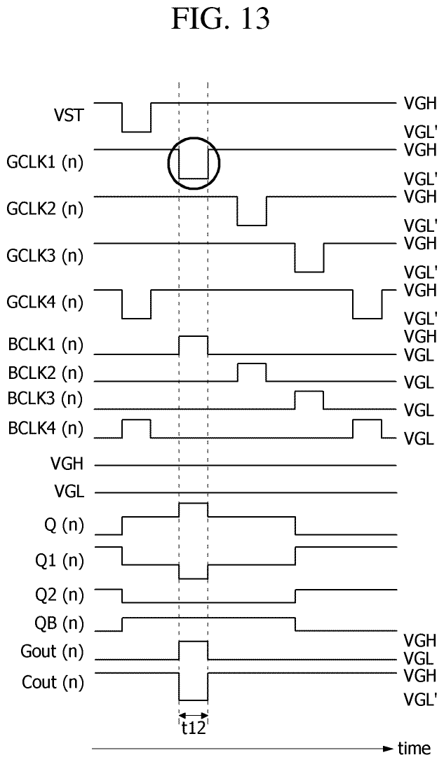

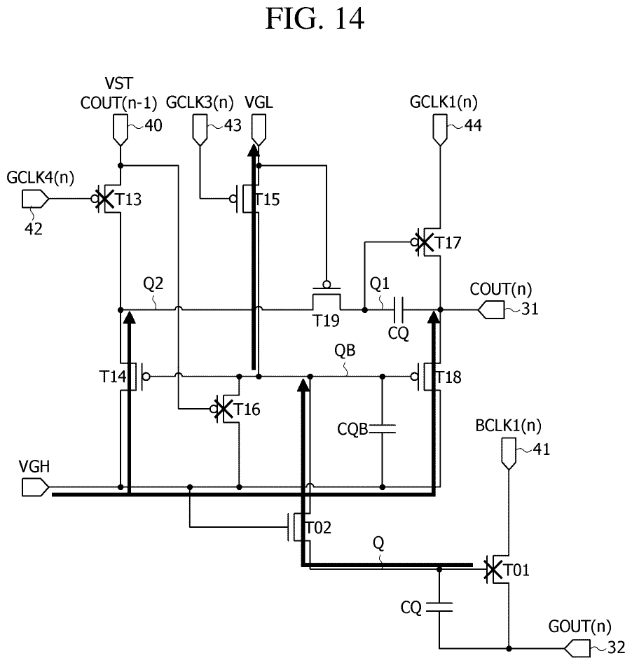

FIGS. 12 and 13 are a circuit diagram and a waveform chart illustrating an operation of the gate driving circuit illustrated in FIG. 7 in a t12 period, in accordance with an embodiment.

Referring to FIGS. 12 and 13, in the t12 period, the pulse of the first G clock signal GCLK1(n) is applied to the seventh transistor T17, and the pulse of the first B clock signal BCLK1(n) is applied to the first transistor T01. A pulse interval voltage of the first G clock signal GCLK1(n) is the gate low voltage VGL′, and a pulse interval voltage of the first B clock signal BCLK1(n) is the gate high voltage VGH. The first and seventh transistors T01 and T17 are in the on state in the t12 period. In the t12 period, the voltage of the Q1 node Q1(n) is boosted to a voltage lower than the gate low voltage VGL′ by bootstrapping, and the voltage of the Q node Q(n) is boosted to a voltage higher than the gate high voltage VGH by bootstrapping. As a result, in the t12 period, the voltage of the first output signal COUT(n) is decreased to the gate low voltage VGL′, and the voltage of the second output signal GOUT(n) is increased to the gate high voltage VGH.

The second transistor T02, the third transistor T13, the fourth transistor T14, the fifth transistor T15, the sixth transistor T16, the eighth transistor T18, and the ninth transistor T19 are turned off in the t12 period.

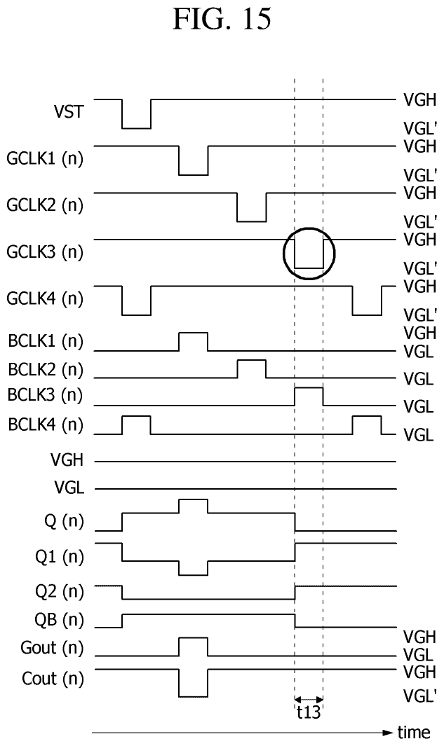

FIGS. 14 and 15 are a circuit diagram and a waveform chart illustrating an operation of the gate driving circuit illustrated in FIG. 7 in a t13 period, in accordance with an embodiment.

Referring to FIGS. 14 and 15, in the t13 period, the pulse of the third G clock signal GCLK3(n) is applied to the gate electrode of the fifth transistor T15. A pulse interval voltage of the third G clock signal GCLK3(n) is the gate low voltage VGL′. In the t13 period, voltages of other G clock signals GCLK1(n), GCLK2(n), and GCLK4(n) are the gate high voltage VGH. In the t13 period, a pulse of a third B clock signal BCLK3(n) is generated, a voltage of the third B clock signal BCLK3(n) is the gate high voltage VGH, and voltages of other B clock signals BCLK1(n), BCLK2(n), BCLK4(n) are the gate low voltage VGL.

In the t13 period, the third transistor T13 and the sixth transistor T16 are turned off. In the t13 period, the second transistor T02, the fifth transistor T15, and the ninth transistor T19 are turned on, the voltages of the QB node QB(n) and the Q node Q(n) are decreased to the gate low voltage VGL, and the fourth transistor T14 and the eighth transistor T18 are turned on and the first transistor T01 is turned off. Simultaneously, the voltages of the Q1 node Q1(n) and the Q2 node Q2(n) are increased to the gate high voltage VGH, and the seventh transistor T17 is turned off. As a result, in the t13 period, the voltage of the first output signal COUT(n) is the gate high voltage VGH, and the voltage of the second output signal GOUT(n) is the gate low voltage VGL.

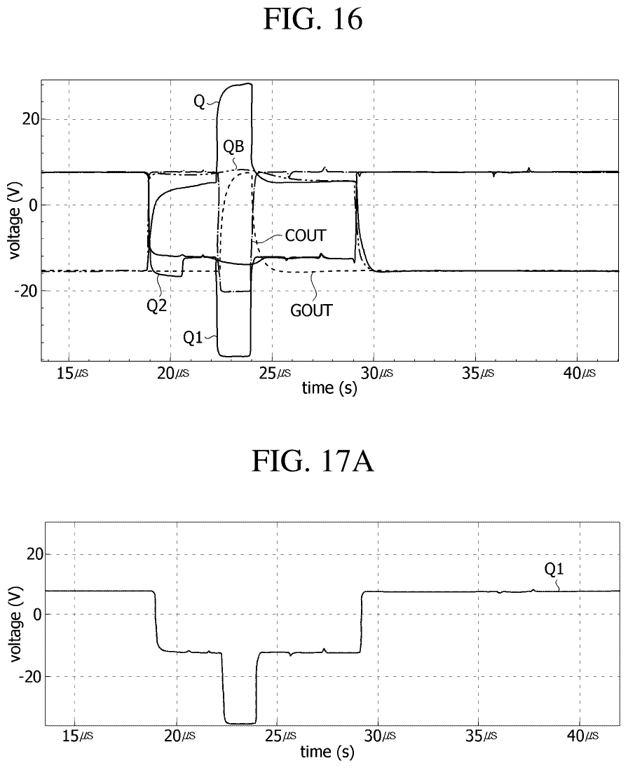

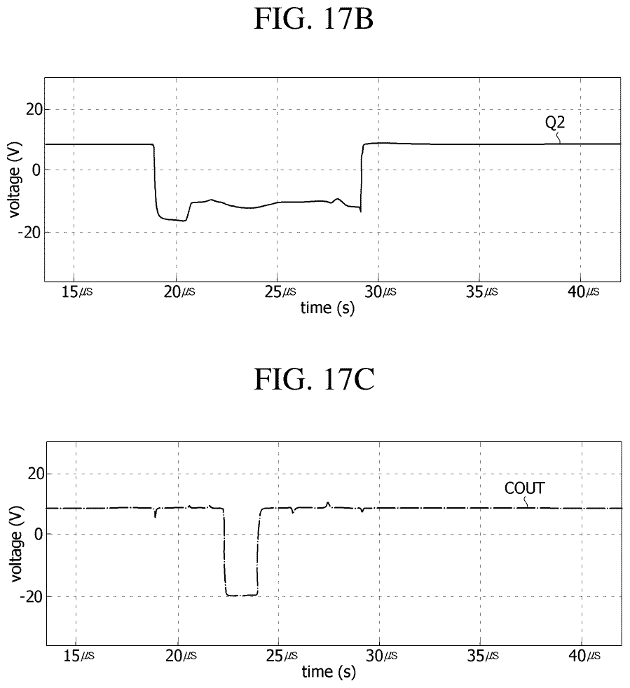

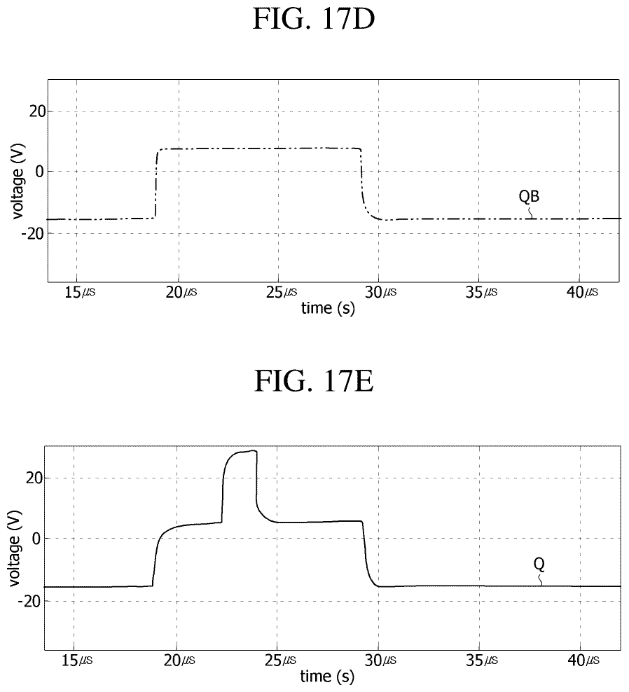

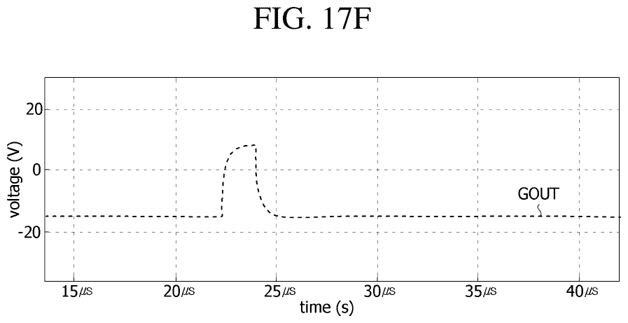

FIGS. 16 to 17F are diagrams illustrating a simulation result of the gate driving circuit illustrated in FIG. 7. In FIGS. 16 to 17F, the horizontal axis[s] represents time and the vertical axis represents a voltage [V]. As will be understood from FIGS. 16 to 17F, the voltage waveform of the Q node has a phase opposite to the voltages of the Q 1 node and the Q2 node, and has the same phase as the voltage of the QB node. A waveform of the second output signal GOUT has a phase opposite to the first output signal COUT.

FIG. 18 is a circuit diagram illustrating an example of an edge trigger circuit that can be applied to the first circuit part of the gate driving circuit illustrated in each of FIGS. 4 to 6. The edge trigger circuit may output a signal the voltage of which varies at an edge of a clock, and is used to output a signal having a pulse interval (pulse width) of one horizontal period or more. A gate signal output from the edge trigger circuit may be applied in common to pixels of two pixel lines or more. In the circuit illustrated in FIG. 18, redundant description of the above-described embodiments will not be repeated.

Referring to FIG. 18, a first circuit part GIP(n) includes a Q1 node, a Q2 node, a QB node, and a plurality of transistors T23 to T29. Each of the transistors T23 to T29 may be implemented by a p-channel transistor, but the embodiments of the present disclosure are not limited thereto.

A third transistor T23 is connected between a VST node 50 and the Q2 node. The third transistor T23 is turned on in response to a first G clock signal GCLK1(n) and electrically connects the VST node 50 to the Q2 node. A start pulse VST or a carry signal from a previous signal transmitter, for example, an (n−2)th signal transmitter, that is, a first output signal COUT(n−2) is input to the VST node 50. When the third transistor T23 is turned on, the Q2 node may be discharged to the gate low voltage VGL of the VST node 50. The third transistor T23 includes a gate electrode connected to a second clock node 52 to which the first G clock signal GCLK1(n) is input, a first electrode connected to the VST node 50, and a second electrode connected to the Q2 node.

A capacitor CON is connected between the second clock node 52 and gate electrodes of fifth transistors T251 and T252. A fourth transistor T24 charges and discharges the gate electrodes of the fifth transistors T251 and T252 in response to a voltage of the VST node 50. When the fourth transistor T24 is turned off in response to the gate high voltage VGH of the VST node 50, the fifth transistors T251 and T252 may be turned on in response to a voltage of the second clock node 52 to which the gate electrodes of the fifth transistors T251 and T252 are coupled via the capacitor CON. When the fourth transistor T24 is turned on in response to the gate low voltage VGL of the VST node 50, a VGH node may be electrically connected to the gate electrodes of the fifth transistors T251 and T252, and the fifth transistors T251 and T252 may be turned off. The fourth transistor T24 includes a gate electrode connected to the VST node 50, a first electrode connected to the capacitor CON and the gate electrodes of the fifth transistors T251 and T252, and a second electrode connected to the VGH node. The fourth transistor T24 is coupled to the second clock node 52 via the capacitor CON.

The fifth transistors T251 and T252 may electrically connect the second clock node 52 to the QB node according to voltages that are applied to the gate electrodes. When the fifth transistors T251 and T252 are a single transistor, the fifth transistors T251 and T252 include a gate electrode connected to the second clock node 52 via the capacitor CON, a first electrode connected to the second clock node 52, and a second electrode connected to the QB node. The fifth transistors T251 and T252 may be implemented by a dual transistor as illustrated in FIG. 18. In this case, a fifth-first transistor T251 includes a gate electrode connected to the capacitor CON and the first electrode of the fourth transistor T24, a first electrode connected to the second clock node 52, and a second electrode connected to a first electrode of a fifth-second switch element T252. The fifth-second switch element T252 includes a gate electrode connected to the capacitor CON and the first electrode of the fourth transistor T24, the first electrode connected to the second electrode of the fifth-first switch element T251, and a second electrode connected to the QB node.

A sixth transistor T26 is connected between the QB node and the VGH node. The sixth transistor T26 may be turned on in response to a voltage of the Q2 node and may electrically connect the QB node to the VGH node. When the sixth transistor T26 is turned on, the QB node may be charged with the gate high voltage VGH. The sixth transistor T26 includes a gate electrode connected to the Q2 node, a first electrode connected to the QB node, and a second electrode connected to the VGH node.

The fifth and sixth transistors T251, T252, and T26 configure an inverter circuit INV that charges and discharges a voltage of the QB node to a voltage with a phase opposite to the voltage of the Q2 node.

Seventh and eighth transistors T27 and T28 are output transistors that output a pulse of a first output signal COUT(n). The seventh transistor T27 is connected between a VGL node and a first output node 61, and is turned on in response to a voltage of the Q1 node. When the voltage of the Q1 node is the gate low voltage VGL, the seventh transistor T27 is turned on, and the VGL node is electrically connected to the first output node 61. As a result, the voltage of the first output node 61 may be discharged to the gate low voltage VGL. The seventh transistor T27 includes a gate electrode connected to the Q1 node, a first electrode connected to the VGL node, and a second electrode connected to the first output node 61. A capacitor CQ1 is connected between the Q1 node and the first output node 61.

The eighth transistor T28 is connected between the first output node 61 and the VGH node, and is turned on the voltage of the QB node. When the voltage of the QB node is the gate low voltage VGL, the eighth transistor T28 is turned on, and the first output node 61 is connected to the VGH node. As a result, the voltage of the first output signal COUT(n) is increased to the gate high voltage VGH. The eighth transistor T28 includes a gate electrode connected to the QB node, a first electrode connected to the first output node 61, and a second electrode connected to the VGH node. A capacitor CQB is connected between the QB node and the VGH node.

A ninth transistor T29 is connected between the Q1 node and the Q2 node. When the Q2 node is discharged to the gate low voltage VGL, the Q1 node may be discharged to the gate low voltage VGL via the ninth transistor T29. When the Q1 node reaches the gate low voltage VGL, a gate-source voltage of the ninth transistor T29 may be Vgs=VGL−VGL=0 V, and the ninth transistor T29 may be turned off. In this case, the Q1 node and the Q2 node may be electrically separated. When the voltage of the Q2 node is charged to the gate high voltage VGH, the Q1 node may be charged with the gate high voltage VGH via the ninth transistor T29. The ninth transistor T29 includes a gate electrode connected to the VGL node, a first electrode connected to the Q1 node, and a second electrode connected to the Q2 node.

FIG. 19 is a diagram schematically illustrating a configuration of a gate driver to which the gate driving circuit illustrated in FIGS. 4 and 18 can be applied. FIG. 20 is a waveform chart illustrating input and output signals of the gate driver illustrated in FIG. 19 and voltages of main nodes.

Referring to FIGS. 19 and 20, a gate driver 120 includes signal transmitters that are connected in a cascade manner via clock lines CL and carry signal lines. The signal transmitters include first circuit parts GIP(n−1) to GIP(n+2) and second circuit parts GIP2, respectively.

The signal transmitters may receive a start pulse VST or first output signals COUT(n−1) and COUT(n+1) from previous signal transmitters, and clock signals GCLK1, GCLK2, and BCLK1 to BCLK4. The clock signals GCLK1, GCLK2, and BCLK1 to BCLK4 may be divided into a G clock set GCLK1 and GCLK2 that is input to the first circuit parts GIP(n−1) to GIP(n+2) and a B clock set BCLK1 to BCLK4 that is input to the second circuit parts GIP2. As illustrated in FIG. 20, the G clock set GCLK1 and GCLK2 may be a two-phase clock in which a pulse is sequentially shifted, but the embodiments of the present disclosure are not limited thereto. The B clock set BCLK1 to BCLK4 may be a four-phase clock in which a pulse is sequentially shifted, but the embodiments of the present disclosure are not limited thereto. The pulses of the B clock set BCLK1 to BCLK4 are shifted in an order of BCLK1(n), BCLK2(n), BCLK3(n), and BCLK4(n) on a time axis.

A pulse interval voltage of the start pulse VST is the gate low voltage VGL. A pulse interval (or pulse width) W of the start pulse VST is greater than a pulse interval W1 of the G clock set GCLK1 and GCLK2 and a pulse interval W2 of the B clock set BCLK1 to BCLK4. The pulse interval W1 of the G clock set GCLK1 and GCLK2 is greater than the pulse interval W2 of the B clock set BCLK1 to BCLK4.

A pulse interval voltage of the first output signal COUT(n) is the gate low voltage VGL. A voltage of the first output signal COUT(n) is inverted at a falling edge of a G clock signal GCLK1(n) or GCLK2(n) that is input to the first circuit part GIP(n). A pulse interval of the first output signal COUT(n) may be one pulse cycle of the G clock signal GCLK1(n) or GCLK2(n). A pulse interval voltage of the second output signal GOUT(n) is the gate high voltage VGH. A pulse of the second output signal GOUT(n) is synchronized with the B clock signal BCLK1, BCLK2, BCLK3, or BCLK4 that is input to the second circuit part GIP2. The pulse interval of the first output signal COUT(n) may be greater than a pulse interval of the second output signal GOUT(n).

Since the clock signal of the B clock set BCLK1, BCLK2, BCLK3, or BCLK4 that is input to the second circuit part GIP2 is the gate high voltage VGH in a pulse interval (or pulse width) of a short time, the clock signal of the B clock set is little susceptible to PBTS. Since the transistors T01 and T02 are almost not deteriorated, excellent falling characteristics can be secured in the pulses of the second output signals GOUT(n−1) to GOUT(n+2).

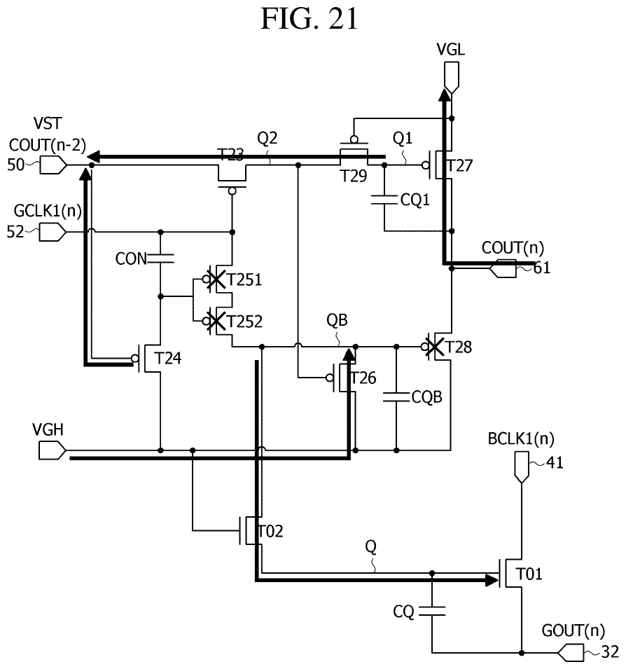

FIGS. 21 to 26 are diagrams illustrating an operation of the gate driving circuit illustrated in FIG. 18 in stages.

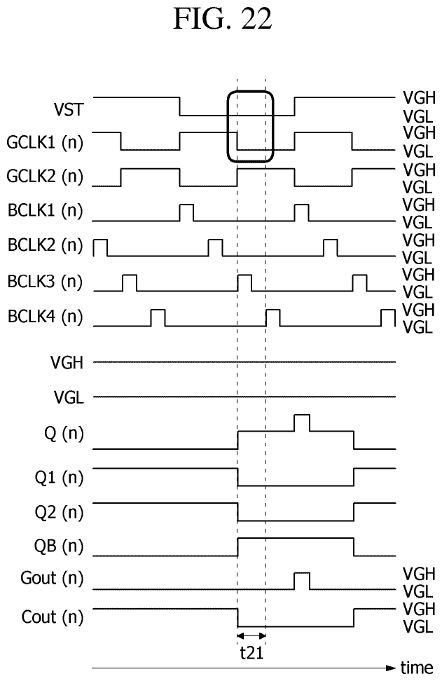

FIGS. 21 and 22 are a circuit diagram and a waveform chart illustrating an operation of the gate driving circuit illustrated in FIG. 18 in a t21 period.

Referring to FIGS. 21 and 22, in the t21 period, the voltages of the start pulse VST and the first G clock signal GCLK1(n) are the gate low voltage VGL. In this case, the third and fourth transistors T23 and T24 are turned on in response to the gate low voltage VGL. The first transistor T01, the second transistor T02, the sixth transistor T26, and the seventh transistor T27, and the ninth transistor T29 are turned on in the t21 period. The fifth and eighth transistors T251, T252, and T28 are turned off in the t21 period. In the t21 period, the voltages of the first output signal COUT(n) and the second output signal GOUT(n) are the gate low voltage VGL.

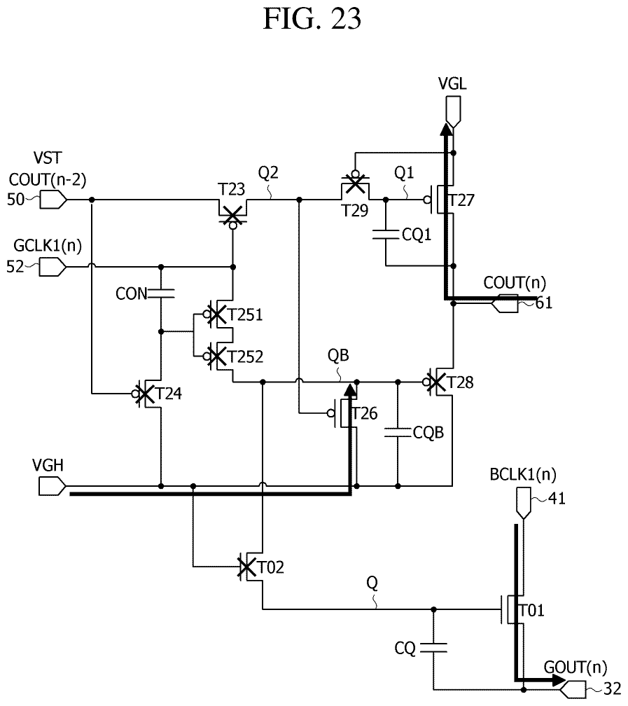

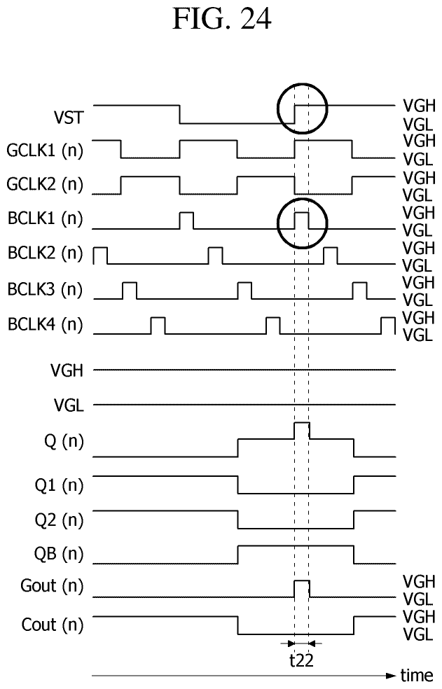

FIGS. 23 and 24 are a circuit diagram and a waveform chart illustrating an operation of the gate driving circuit illustrated in FIG. 18 in a t22 period.

Referring to FIGS. 23 and 24, in the t22 period, the voltages of the start pulse VST and the first G clock signal GCLK1(n) are the gate high voltage VGH, and the voltage of the first B clock signal BCLK1(n) is the gate high voltage VGH. While the first, fourth, and seventh transistors T01, T24, and T27 are turned on in the t22 period, other transistors T02, T23, T24, T251, T252, T26, T28, and T28 are turned off in the t22 period. In the t22 period, the voltage of the first output signal COUT(n) is maintained at the gate low voltage VGL, and the voltage of the second output signal GOUT(n) is the gate high voltage VGH.

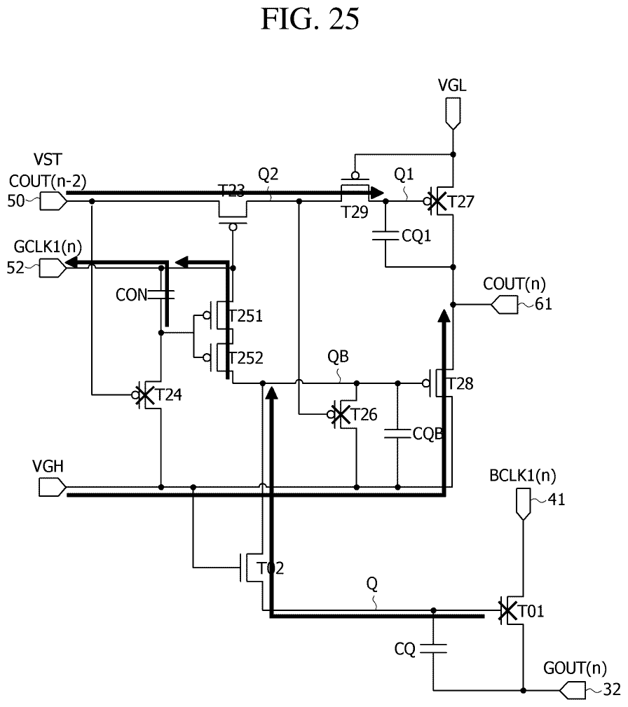

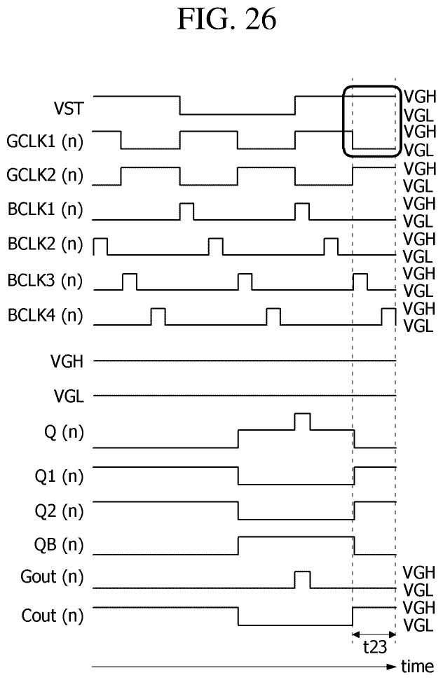

FIGS. 25 and 26 are a circuit diagram and a waveform chart illustrating an operation of the gate driving circuit illustrated in FIG. 18 in a t23 period.

Referring to FIGS. 25 and 26, in the t23 period, the voltage of the start pulse VST is the gate high voltage VGH, and the voltage of the first G clock signal GCLK1(n) is the gate low voltage VGL. The voltage of the first B clock signal BCLK1(n) is the gate low voltage VGL in the t23 period. While the second, third, fifth, eighth, and ninth transistors T02, T23, T251, T252, T28, and T29 are turned on in the t22 period, other transistors T01, T24, T26, and T27 are turned off in the t22 period. In the t23 period, the voltage of the first output signal COUT(n) is the gate high voltage VGH, and the voltage of the second output signal GOUT(n) is the gate low voltage VGL.

According to one or more embodiments of the present disclosure, the display device may be applied to mobile devices, video phones, smart watches, watch phones, wearable device, foldable device, rollable device, bendable device, flexible device, curved device, sliding device, variable device, electronic organizer, electronic books, portable multimedia players (PMPs), personal digital assistants (PDAs), MP3 players, mobile medical devices, desktop PCs, laptop PCs, netbook computers, workstations, navigations, vehicle navigations, vehicle display devices, vehicle devices, theater devices, theater display devices, televisions, wallpaper devices, signage devices, game devices, laptops, monitors, cameras, camcorders, and home appliances, etc. Additionally, the display apparatus according to one or more embodiments of the present disclosure may be applied to organic light emitting lighting devices or inorganic light emitting lighting devices.

The objects to be achieved by the present disclosure, the means for achieving the objects, and effects of the present disclosure described above do not specify essential features of the claims, and thus, the scope of the claims is not limited to the disclosure of the present disclosure.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

What is claimed is:

1. A gate driving circuit comprising:
a first circuit part that includes a Q1 node, a Q2 node, and a QB node, and is configured to output a pulse of a first output signal; and
a second circuit part that is connected to the QB node and is configured to receive a first gate voltage and a clock signal and output at least a pulse of a second output signal,
wherein the second circuit part includes:
a first transistor including a gate electrode connected to a Q node, a first electrode connected to a first clock node to which the clock signal is input, and a second electrode;
a second transistor including a gate electrode to which the first gate voltage is applied, a first electrode connected to the QB node, and a second electrode connected to the Q node; and
a capacitor connected between the gate electrode of the first transistor and the second electrode of the second transistor.

2. The gate driving circuit according to claim 1, wherein:
the first circuit part includes a plurality of p-channel transistors,
each of the first transistor and the second transistor is an n-channel transistor, and
the second electrode of the first transistor is connected to a second output node from which the pulse of the second output signal is output.

3. The gate driving circuit according to claim 1, wherein:
the second circuit part further includes a third transistor including a gate electrode connected to the Q2 node, a first electrode connected to the second electrode of the first transistor, and a second electrode to which a second gate voltage lower than the first gate voltage is applied,
the first circuit part includes a plurality of p-channel transistors,
each of the first transistor, the second transistor, and the third transistor is an n-channel transistor, and
the second electrode of the first transistor is connected to a second output node from which the pulse of the second output signal is output.

4. The gate driving circuit according to claim 1, wherein the second circuit part further includes:
a third transistor including a gate electrode connected to the Q node, a first electrode to which a first B clock signal is input, and a second electrode connected to a second output node from which the pulse of the second output signal is output;
a fourth transistor including a gate electrode connected to the Q node, a first electrode connected to the second output node, and a second electrode to which a second gate voltage lower than the first gate voltage is applied;
a fifth transistor including a gate electrode connected to the Q node, a first electrode to which a second B clock signal is input, and a second electrode connected to a third output node from which a pulse of a third output signal is output; and
a sixth transistor including a gate electrode connected to the Q node, a first electrode connected to the third output node, and a second electrode to which the second gate voltage is applied, and
wherein:
the first circuit part includes a plurality of p-channel transistors,
each of the first transistor, the second transistor, the third transistor, the fourth transistor, the fifth transistor, and the sixth transistor is an n-channel transistor, and
a voltage of the clock signal that is input to the first electrode of the first transistor is the first gate voltage before a pulse of the first B clock signal is generated.

5. The gate driving circuit according to claim 1, wherein the first circuit part includes a shift register including a plurality of p-channel transistors or an edge trigger including a plurality of p-channel transistors.

6. The gate driving circuit according to claim 2, wherein the first circuit part includes:
a third transistor including a gate electrode connected to a second clock node, a first electrode connected to a VST node, and a second electrode connected to the Q2 node;
a fourth transistor including a gate electrode connected to the QB node, a first electrode connected to the Q2 node, and a second electrode connected to a VGH node to which the first gate voltage is input;
a fifth transistor including a gate electrode connected to a third clock node, a first electrode connected to a VGL node to which a second gate voltage lower than the first gate voltage is applied, and a second electrode connected to the QB node;
a sixth transistor including a gate electrode connected to the VST node, a first electrode connected to the QB node, and a second electrode connected to the VGH node,
a seventh transistor including a gate electrode connected to the Q1 node, a first electrode connected to a fourth clock node, and a second electrode connected to a first output node from which the pulse of the first output signal is output;
an eighth transistor including a gate electrode connected to the QB node, a first electrode connected to the first output node, and a second electrode connected to the VGH node; and
a ninth transistor including a gate electrode connected to the VGL node, a first electrode connected to the Q1 node, and a second electrode connected to the Q2 node, and
each of the third transistor, the fourth transistor, the fifth transistor, the sixth transistor, the seventh transistor, the eighth transistor, and the ninth transistor is a p-channel transistor.

7. The gate driving circuit according to claim 6, wherein the clock signal that is input to the first clock node is a signal with a phase opposite to a clock signal that is input to the fourth clock node.

8. The gate driving circuit according to claim 7, wherein:
a pulse interval voltage of the clock signal that is input to the first clock node is the first gate voltage, and
a pulse interval voltage of each of clock signals that are input to the second clock node, the third clock node, and the fourth clock node, respectively, is the second gate voltage.

9. The gate driving circuit according to claim 8, wherein:
in an interval other than a pulse interval of the clock signal, the second gate voltage lower than the first gate voltage is applied to each of the first clock node, the second clock node, the third clock node, and the fourth clock node, and
the second gate voltage that is input to each of the second clock node, the third clock node, and the fourth clock node is equal to or lower than the second gate voltage that is applied to the first clock node.

10. The gate driving circuit according to claim 6, wherein:
a voltage waveform of the Q node has a phase opposite to a voltage of the Q1 node and a voltage of the Q2 node, and
the voltage waveform of the Q node has a same phase as a voltage of the QB node.

11. The gate driving circuit according to claim 6, wherein a waveform of the second output signal is a waveform with a phase opposite to the first output signal.

12. The gate driving circuit according to claim 2, wherein the first circuit part further includes:
a third transistor including a gate electrode connected to a second clock node, a first electrode connected to a VST node, and a second electrode connected to the Q2 node;
a fourth transistor including a gate electrode connected to the VST node, a first electrode connected to the second clock node via a second capacitor, and a second electrode connected to a VGH node to which the first gate voltage is applied;
a fifth transistor including a gate electrode connected to the second clock node via the second capacitor, a first electrode connected to the second clock node, and a second electrode connected to the QB node;
a sixth transistor including a gate electrode connected to the Q2 node, a first electrode connected to the QB node, and a second electrode connected to the VGH node;
a seventh transistor including a gate electrode connected to the Q1 node, a first electrode connected to a VGL node to which a second gate voltage lower than the first gate voltage is applied, and a second electrode connected to a first output node from which the pulse of the first output signal is output;
an eighth transistor including a gate electrode connected to the QB node, a first electrode connected to the first output node, and a second electrode connected to the VGH node; and
a ninth transistor including a gate electrode connected to the VGL node, a first electrode connected to the Q1 node, and a second electrode connected to the Q2 node.

13. The gate driving circuit according to claim 12, wherein:
a pulse interval voltage of the clock signal that is input to the first clock node is the first gate voltage, and
a pulse interval voltage of a clock signal that is input to the second clock node is the second gate voltage.

14. The gate driving circuit according to claim 13, wherein a pulse interval of the clock signal that is input to the second clock node is greater than a pulse interval of the clock signal that is input to the first clock node.

15. The gate driving circuit according to claim 14, wherein a pulse interval of the first output signal is greater than a pulse interval of the second output signal.

16. A display device comprising:
a display panel in which a plurality of data lines, a plurality of gate lines, a plurality of pixels connected to corresponding data lines and gate lines, and a gate driving circuit configured to output a gate signal to the plurality of gate lines are provided,
wherein each of the plurality of pixels includes a plurality of n-channel transistors that are switched in response to the gate signal,
wherein the gate driving circuit includes:
a first circuit part that includes a Q1 node, a Q2 node, and a QB node, and is configured to output a pulse of a carry signal; and
a second circuit part that is connected to the QB node, and is configured to receive a first gate voltage and a clock signal and output a pulse of the gate signal, and
wherein the second circuit part includes:
a first transistor including a gate electrode connected to a Q node, a first electrode connected to a first clock node to which the clock signal is input, and a second electrode;
a second transistor including a gate electrode to which the first gate voltage is applied, a first electrode connected to the QB node, and a second electrode connected to the Q node; and
a capacitor connected between the gate electrode of the first transistor and the second electrode of the second transistor.

17. The display device according to claim 16, wherein:
the first circuit part includes a plurality of p-channel transistors,
each of the first transistor and the second transistor is an n-channel transistor, and
the second electrode of the first transistor is connected to a second output node from which the pulse of the gate signal is output.

18. The display device according to claim 16, wherein the second circuit part further includes:
a third transistor including a gate electrode connected to the Q2 node, a first electrode connected to the second electrode of the first transistor, and a second electrode to which a second gate voltage lower than the first gate voltage is applied,
the first circuit part includes a plurality of p-channel transistors,
each of the first transistor, the second transistor, and the third transistor is an n-channel transistor, and
the second electrode of the first transistor is connected to a second output node from which the pulse of the gate signal is output.

19. The display device according to claim 16, wherein the second circuit part further includes:
a third transistor including a gate electrode connected to the Q node, a first electrode to which a first B clock signal is input, and a second electrode connected to a second output node from which a pulse of a first gate signal is output;,
a fourth transistor including a gate electrode connected to the Q node, a first electrode connected to the second output node, and a second electrode to which a second gate voltage lower than the first gate voltage is applied;
a fifth transistor including a gate electrode connected to the Q node, a first electrode to which a second B clock signal is input, and a second electrode connected to a third output node from which a pulse of a second gate signal is output; and
a sixth transistor including a gate electrode connected to the Q node, a first electrode connected to the third output node, and a second electrode to which the second gate voltage is applied, and
wherein:
the first circuit part includes a plurality of p-channel transistors,
each of the first transistor, the second transistor, the third transistor, the fourth transistor, the fifth transistor, and the sixth transistor is an n-channel transistor, and
a voltage of the clock signal that is input to the first electrode of the first transistor is the first gate voltage before a pulse of the first B clock signal is generated.

20. The display device according to claim 16, wherein the first circuit part includes a shift register including a plurality of p-channel transistors or an edge trigger including a plurality of p-channel transistors.
